(19) United States
(12) Patent Application Publication
(10) Pub. No.: US 2026/0312730 A1
(43) Pub. Date: Oct. 8, 2026

(54) TECHNIQUES FOR NETWORK CODING BASED ON DEVICE STORAGE

(71) Applicant: QUALCOMM Incorporated, San Diego, CA (US)

(72) Inventors: Kangqi LIU, San Diego, CA (US); Changlong XU, Beijing (CN); Liangming WU, Beijing (CN); Jian LI, Shanghai (CN); Ruiming ZHENG, Beijing (CN); Hao XU, Beijing (CN)

(21) Appl. No.: 18/996,713

(22) PCT Filed: Aug. 25, 2022
(86) PCT No.: PCT/CN2022/114692

§ 371 Date: Jan. 17, 2025

(51) Int. Cl. H04L 1/00; H04L 1/1607; H04L 1/1867

(52) U.S. Cl. CPC H04L 1/0076; H04L 1/1607; H04L 1/189

(57) ABSTRACT

Methods, systems, and devices for wireless communications are described. A wireless device may receive a set of sidelink messages via one or more sidelink channels, where a group of sidelink messages of the set of sidelink messages is associated with feedback information requesting retransmission for each sidelink message. The wireless device may generate one or more network coded combined messages corresponding to one or more subsets of sidelink messages of the group of sidelink messages based on the feedback information. For example, the wireless device may perform an exclusive or operation on two or more sidelink messages of the group of sidelink messages to obtain a network coded combined message corresponding to a subset of sidelink messages. The wireless device may transmit, via the one or more sidelink channels, the one or more network coded combined messages and an indication of the one or more subsets of sidelink messages.

### CROSS REFERENCE

The present Application is a 371 national phase filing of International PCT Application No. PCT/CN2022/114692 by LIU et al., entitled “TECHNIQUES FOR NETWORK CODING BASED ON DEVICE STORAGE,” filed Aug. 25, 2022, which is assigned to the assignee hereof, and which is expressly incorporated by reference in its entirety herein.

### FIELD OF DISCLOSURE

The present disclosure relates to wireless communications, including techniques for network coding based on device storage.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support sidelink communications between UEs. For example, a first UE may transmit a groupcast transmission to a group of UEs. Receiving UEs of the group of UEs may transmit feedback information for the groupcast transmission to the first UE, such as a negative acknowledgement (NACK) that indicates a failed reception. The first UE may retransmit the groupcast transmission to each UE that indicated a NACK. Retransmissions may improve reliability of sidelink communications, but may also increase resource usage, overhead, and latency.

### SUMMARY

The described techniques relate to improved methods, systems, devices, and apparatuses that support techniques for network coding based on device storage. For example, the described techniques provide for a wireless device, such as a relay node, to generate one or more network coded combined messages for a set of sidelink messages based on receiving feedback associated with the set of sidelink messages. Each UE of a group of UEs may transmit (e.g., groupcast) a respective sidelink message of the set of sidelink messages to other UEs in the group and to the relay node. Based on receiving the set of sidelink messages, each UE may transmit feedback information associated with the set of sidelink messages, such as a negative acknowledgment (NACK) or a positive acknowledgement (ACK). The relay node may also receive the feedback information, and may generate the one or more network coded combined messages based on the feedback information. For example, the relay node may utilize network coding to combine the contents of a subset of sidelink messages of the set of sidelink messages, such as sidelink messages associated with a NACK. The relay may transmit the one or more network coded combined messages to the group of UEs. Each UE of the group of UEs may utilize the one or more network coded combined messages to decode or otherwise recover the subset of sidelink messages. In some cases, the relay node may generate the one or more network coded combined messages based on a storage capability of UEs in the group of UEs.

A method for wireless communication at a relay node is described. The method may include receiving a set of multiple sidelink messages via one or more sidelink channels, the set of multiple sidelink messages including a group of sidelink messages associated with feedback information requesting retransmission for each sidelink message of the group of sidelink messages, generating one or more network coded combined messages corresponding to one or more subsets of sidelink messages of the group of sidelink messages based on the feedback information, and transmitting, via the one or more sidelink channels, the one or more network coded combined messages and an indication of the one or more subsets of sidelink messages of the group of sidelink messages.

An apparatus for wireless communication at a relay node is described. The apparatus may include a processor, memory coupled with the processor, and instructions stored in the memory. The instructions may be executable by the processor to cause the apparatus to receive a set of multiple sidelink messages via one or more sidelink channels, the set of multiple sidelink messages including a group of sidelink messages associated with feedback information requesting retransmission for each sidelink message of the group of sidelink messages, generate one or more network coded combined messages corresponding to one or more subsets of sidelink messages of the group of sidelink messages based on the feedback information, and transmit, via the one or more sidelink channels, the one or more network coded combined messages and an indication of the one or more subsets of sidelink messages of the group of sidelink messages.

Another apparatus for wireless communication at a relay node is described. The apparatus may include means for receiving a set of multiple sidelink messages via one or more sidelink channels, the set of multiple sidelink messages including a group of sidelink messages associated with feedback information requesting retransmission for each sidelink message of the group of sidelink messages, means for generating one or more network coded combined messages corresponding to one or more subsets of sidelink messages of the group of sidelink messages based on the feedback information, and means for transmitting, via the one or more sidelink channels, the one or more network coded combined messages and an indication of the one or more subsets of sidelink messages of the group of sidelink messages.

A non-transitory computer-readable medium storing code for wireless communication at a relay node is described. The code may include instructions executable by a processor to receive a set of multiple sidelink messages via one or more sidelink channels, the set of multiple sidelink messages including a group of sidelink messages associated with feedback information requesting retransmission for each sidelink message of the group of sidelink messages, generate one or more network coded combined messages corresponding to one or more subsets of sidelink messages of the group of sidelink messages based on the feedback information, and transmit, via the one or more sidelink channels, the one or more network coded combined messages and an indication of the one or more subsets of sidelink messages of the group of sidelink messages.

Some examples of the method, apparatuses, and non-transitory computer-readable medium described herein may further include operations, features, means, or instructions for receiving the feedback information from a set of multiple UEs based on receiving the set of multiple sidelink messages, where generating the one or more network coded combined messages may be based on receiving the feedback information.

In some examples of the method, apparatuses, and non-transitory computer-readable medium described herein, the feedback information indicates a negative acknowledgement, a positive acknowledgement, or a combination thereof, for one or more sidelink messages of the group of sidelink messages.

In some examples of the method, apparatuses, and non-transitory computer-readable medium described herein, the feedback information indicates, for each user equipment (UE) of the set of multiple UEs, a storage capability for storing a set of decoded sidelink messages.

In some examples of the method, apparatuses, and non-transitory computer-readable medium described herein, the storage capability indicates a capability to store a quantity of decoded sidelink messages, a quantity of sidelink messages for which the UE may have performed an exclusive or operation, or any combination thereof, for the set of decoded sidelink messages.

In some examples of the method, apparatuses, and non-transitory computer-readable medium described herein, the feedback information indicates, for each UE of the set of multiple UEs, one or more decoded sidelink messages stored at the UE, one or more network coded sidelink messages stored at the UE, or a combination thereof.

In some examples of the method, apparatuses, and non-transitory computer-readable medium described herein, generating the one or more network coded combined messages may include operations, features, means, or instructions for performing an exclusive or operation on two or more sidelink messages of the group of sidelink messages to generate a subset of sidelink messages of the one or more subsets of sidelink messages, where transmitting the one or more network coded combined messages may be based on performing the exclusive or operation.

Some examples of the method, apparatuses, and non-transitory computer-readable medium described herein may further include operations, features, means, or instructions for generating a first matrix including first values, the first values indicating a requested retransmission for one or more sidelink messages of the group of sidelink messages based on the feedback information, where generating the one or more network coded combined messages corresponding to the one or more subsets of sidelink messages may be based on the first matrix.

In some examples of the method, apparatuses, and non-transitory computer-readable medium described herein, each column of the first matrix corresponds to a respective sidelink message of the group of sidelink messages and each row of the first matrix corresponds to a respective UE of a set of multiple UEs associated with the feedback information.

Some examples of the method, apparatuses, and non-transitory computer-readable medium described herein may further include operations, features, means, or instructions for identifying a first set of sidelink messages of the set of multiple sidelink messages for which a UE requests retransmission and a second set of sidelink messages of the set of multiple sidelink messages for which the UE fails to request retransmission, generating, for the UE, one or more rows in the first matrix, each row of the one or more rows corresponding to a respective sidelink message of the first set of sidelink messages, and identifying, in each row of the first matrix associated with the UE, the second set of sidelink messages using one or more second values.

Some examples of the method, apparatuses, and non-transitory computer-readable medium described herein may further include operations, features, means, or instructions for generating a second matrix based on determining two or more first values of the first matrix that represent a sidelink message stored at a same storage location.

Some examples of the method, apparatuses, and non-transitory computer-readable medium described herein may further include operations, features, means, or instructions for adjusting a value of one of the two or more first values to reduce a rank associated with the first matrix, where generating the second matrix may be based on adjusting the value.

Some examples of the method, apparatuses, and non-transitory computer-readable medium described herein may further include operations, features, means, or instructions for generating a third matrix based on a row basis of the second matrix, where generating the one or more network coded combined messages corresponding to the one or more subsets of sidelink messages of the group of sidelink messages may be based on generating the third matrix.

In some examples of the method, apparatuses, and non-transitory computer-readable medium described herein, the indication of the one or more subsets of sidelink messages includes one or more rows of the third matrix.

Some examples of the method, apparatuses, and non-transitory computer-readable medium described herein may further include operations, features, means, or instructions for generating a third matrix based on a row basis of the first matrix, where generating the one or more network coded combined messages corresponding to the one or more subsets of sidelink messages of the group of sidelink messages may be based on generating the third matrix.

In some examples of the method, apparatuses, and non-transitory computer-readable medium described herein, the indication of the one or more subsets of sidelink messages includes one or more rows of the third matrix.

Some examples of the method, apparatuses, and non-transitory computer-readable medium described herein may further include operations, features, means, or instructions for identifying a reliability threshold for one or more sidelink messages of the set of multiple sidelink messages, where transmitting the one or more network coded combined messages may be based on the reliability threshold.

In some examples of the method, apparatuses, and non-transitory computer-readable medium described herein, the one or more network coded combined messages may be associated with an internet protocol layer, a packet data convergence protocol layer, a radio link control layer, a medium access control layer, or any combination thereof.

In some examples of the method, apparatuses, and non-transitory computer-readable medium described herein, the relay node includes a sidelink UE.

Some examples of the method, apparatuses, and non-transitory computer-readable medium described herein may further include operations, features, means, or instructions for transmitting SCI indicating whether one or more sidelink messages scheduled by the SCI may be network coded combined messages.

A method for wireless communication at a UE is described. The method may include transmitting a sidelink message to one or more UEs of a set of multiple UEs, receiving a set of sidelink messages from the set of multiple UEs via one or more sidelink channels, transmitting feedback information associated with the set of sidelink messages, the feedback information requesting retransmission for at least one sidelink message of the set of sidelink messages, and receiving one or more network coded combined messages corresponding to one or more subsets of sidelink messages of the set of sidelink messages including the at least one sidelink message based on the feedback information, the one or more network coded combined messages including an indication of the one or more subsets of sidelink messages.

An apparatus for wireless communication at a UE is described. The apparatus may include a processor, memory coupled with the processor, and instructions stored in the memory. The instructions may be executable by the processor to cause the apparatus to transmit a sidelink message to one or more UEs of a set of multiple UEs, receive a set of sidelink messages from the set of multiple UEs via one or more sidelink channels, transmit feedback information associated with the set of sidelink messages, the feedback information requesting retransmission for at least one sidelink message of the set of sidelink messages, and receive one or more network coded combined messages corresponding to one or more subsets of sidelink messages of the set of sidelink messages including the at least one sidelink message based on the feedback information, the one or more network coded combined messages including an indication of the one or more subsets of sidelink messages.

Another apparatus for wireless communication at a UE is described. The apparatus may include means for transmitting a sidelink message to one or more UEs of a set of multiple UEs, means for receiving a set of sidelink messages from the set of multiple UEs via one or more sidelink channels, means for transmitting feedback information associated with the set of sidelink messages, the feedback information requesting retransmission for at least one sidelink message of the set of sidelink messages, and means for receiving one or more network coded combined messages corresponding to one or more subsets of sidelink messages of the set of sidelink messages including the at least one sidelink message based on the feedback information, the one or more network coded combined messages including an indication of the one or more subsets of sidelink messages.

A non-transitory computer-readable medium storing code for wireless communication at a UE is described. The code may include instructions executable by a processor to transmit a sidelink message to one or more UEs of a set of multiple UEs, receive a set of sidelink messages from the set of multiple UEs via one or more sidelink channels, transmit feedback information associated with the set of sidelink messages, the feedback information requesting retransmission for at least one sidelink message of the set of sidelink messages, and receive one or more network coded combined messages corresponding to one or more subsets of sidelink messages of the set of sidelink messages including the at least one sidelink message based on the feedback information, the one or more network coded combined messages including an indication of the one or more subsets of sidelink messages.

In some examples of the method, apparatuses, and non-transitory computer-readable medium described herein, the feedback information indicates a negative acknowledgement, a positive acknowledgement, or a combination thereof, for each sidelink message of the set of sidelink messages.

In some examples of the method, apparatuses, and non-transitory computer-readable medium described herein, the feedback information indicates a storage capability of the UE for storing a set of decoded sidelink messages.

In some examples of the method, apparatuses, and non-transitory computer-readable medium described herein, the storage capability indicates a capability of the UE to store a quantity of decoded sidelink messages, a quantity of network coded sidelink messages, or any combination thereof, for the set of sidelink messages.

In some examples of the method, apparatuses, and non-transitory computer-readable medium described herein, the storage capability indicates one or more decoded sidelink messages stored at the UE, one or more network coded sidelink messages stored at the UE, or a combination thereof.

Some examples of the method, apparatuses, and non-transitory computer-readable medium described herein may further include operations, features, means, or instructions for storing, at the UE, one or more decoded sidelink messages of the set of sidelink messages and performing an exclusive or operation on the one or more decoded sidelink messages, the sidelink message, and the one or more network coded combined messages to obtain the at least one sidelink message.

In some examples of the method, apparatuses, and non-transitory computer-readable medium described herein, the feedback information indicates a storage capability of the UE for storing the one or more decoded sidelink messages.

In some examples of the method, apparatuses, and non-transitory computer-readable medium described herein, the feedback information indicates the one or more decoded sidelink messages stored at the UE.

Some examples of the method, apparatuses, and non-transitory computer-readable medium described herein may further include operations, features, means, or instructions for performing an exclusive or operation on the sidelink message and one or more decoded sidelink messages of the set of sidelink messages to obtain a network coded sidelink message, storing, at the UE, the network coded sidelink message, and performing an exclusive or operation on the network coded sidelink message and the one or more network coded combined messages to obtain the at least one sidelink message.

In some examples of the method, apparatuses, and non-transitory computer-readable medium described herein, the feedback information indicates a storage capability of the UE for storing the network coded sidelink message.

In some examples of the method, apparatuses, and non-transitory computer-readable medium described herein, the feedback information indicates the one or more decoded sidelink messages associated with the network coded sidelink message stored at the UE.

In some examples of the method, apparatuses, and non-transitory computer-readable medium described herein, the one or more network coded combined messages may be associated with an internet protocol layer, a packet data convergence protocol layer, a radio link control layer, a medium access control layer, or any combination thereof.

In some examples of the method, apparatuses, and non-transitory computer-readable medium described herein, the one or more network coded combined messages may be received from a relay node.

Some examples of the method, apparatuses, and non-transitory computer-readable medium described herein may further include operations, features, means, or instructions for receiving SCI indicating whether one or more sidelink messages scheduled by the SCI may be network coded combined messages.

### BRIEF DESCRIPTION OF THE DRAWINGS

FIGS. 1 and 2 illustrates examples of wireless communications systems that support techniques for network coding based on device storage in accordance with one or more aspects of the present disclosure.

FIGS. 3 through 5 illustrate examples of algorithmic retransmission schemes that support techniques for network coding based on device storage in accordance with one or more aspects of the present disclosure.

FIG. 6 illustrates an example of a process flow that supports techniques for network coding based on device storage in accordance with one or more aspects of the present disclosure.

FIGS. 7 and 8 show block diagrams of devices that support techniques for network coding based on device storage in accordance with one or more aspects of the present disclosure.

FIG. 9 shows a block diagram of a communications manager that supports techniques for network coding based on device storage in accordance with one or more aspects of the present disclosure.

FIG. 10 shows a diagram of a system including a device that supports techniques for network coding based on device storage in accordance with one or more aspects of the present disclosure.

FIGS. 11 and 12 show block diagrams of devices that support techniques for network coding based on device storage in accordance with one or more aspects of the present disclosure.

FIG. 13 shows a block diagram of a communications manager that supports techniques for network coding based on device storage in accordance with one or more aspects of the present disclosure.

FIG. 14 shows a diagram of a system including a device that supports techniques for network coding based on device storage in accordance with one or more aspects of the present disclosure.

FIGS. 15 through 18 show flowcharts illustrating methods that support techniques for network coding based on device storage in accordance with one or more aspects of the present disclosure.

### DETAILED DESCRIPTION

Some wireless communication systems may support access links (e.g., a Uu link) and sidelinks (e.g., a PC5 link) for communications between communication devices. Sidelinks may refer to any communication link between similar communication devices (e.g., a communication link between UEs, or a backhaul link between base stations). Such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

Additionally, some sidelink communication systems may support groupcast communications (e.g., groupcast sidelink communications) in which a transmitting device, such as a UE, may communicate with multiple receivers (e.g., other UEs) in a same group simultaneously. In some cases, each UE of a group of UEs may transmit and receive groupcast transmissions from other UEs of the group of UEs. The UEs may transmit feedback information (e.g., feedback messages) for groupcast transmissions, which may indicate whether a receiving UE successfully decoded a groupcast transmission via a negative acknowledgment (NACK) or a positive acknowledgement (ACK). A NACK may indicate that a receiving UE failed to decode the groupcast transmission and is requested a retransmission of the groupcast transmission.

Retransmission of the groupcast transmission may increase its reliability (e.g., the likelihood the groupcast transmission is successfully received). However, in some cases, retransmissions may increase resource usage, overhead, and latency in the sidelink communication system. For example, a V2X system may rely on retransmissions to achieve relatively high reliability requirements. If a group of UEs in the V2X system is configured to blindly perform retransmissions to support these high reliability requirements, resource usage and overhead may increase. Additionally, as the quantity of UEs in the group of UEs increases, so too does the quantity of feedback messages and retransmissions, which may significantly increase congestion and the likelihood of interference and collisions in the V2X system. Although retransmissions may be intended to improve reliability, rising congestion and associated interference may introduce such performance degradation that reliability is also decreased. Thus, in some scenarios (e.g., in groupcast), it may be advantageous for the UEs to decrease the number of retransmissions in the V2X system.

Techniques, systems, and devices are described herein to improve retransmission methods by enabling network coding for groupcast retransmissions. For example, rather than each UE in the group of UEs transmitting separate retransmissions for each sidelink message based on feedback information, one UE of the group of UEs may transmit, to the group of UEs, a network coded message (e.g., or multiple network coded message) that includes data from multiple sidelink messages. The network coded message may be referred to as a network coded combined message. In some cases, the UE transmitting the network coded combined message may be an example of a relay node or relay UE. Transmitting a network coded combined message in place of multiple retransmissions may decrease an overall number of retransmissions in the system, thereby reducing congestion and latency.

For example, because each UE of the group of UEs transmits via groupcast, the UE may obtain the sidelink messages and corresponding feedback information. To generate the network coded combined message, the UE may combine portions of each sidelink message using network coding techniques, such as exclusive or (XOR) operations. In some examples, the UE may determine sidelink messages to include in the network coded combined message based on the feedback information for the sidelink messages, a storage capability of the UEs, or a combination thereof. For example, the UE may include, in the network coded combined message, data from sidelink messages that are associated with negative feedback information (e.g., NACKs).

A receiving UE in the group of UEs may use the network coded combined message to recover information associated with a sidelink message for which the UE transmitted a NACK. For example, the receiving UE may fail to successfully decode a sidelink message and may indicate the failure via a NACK, but may store information associated with the sidelink message at the receiving UE. Based on the NACK, the network coded combined message may include information associated with the sidelink message. The receiving UE may combine the stored information with the network coded combined message to obtain or otherwise extract the full sidelink message.

Aspects of the subject matter described in this disclosure may be implemented to realize one or more of the following potential improvements, among others. The techniques employed by the described communication devices may enable groupcast retransmissions between UEs to be combined into one or more network coded combined messages, which may increase resource usage efficiency, reduce power consumption, and reduce latency associated with communicating groupcast retransmissions. For example, combining groupcast transmissions in a network coded combined message may reduce an overall quantity of retransmissions communicated between UEs, which may reduce congestion and usage of communication link time and frequency resources. Additionally, in some cases, UEs may recover information associated with multiple unsuccessfully-decoded sidelink messages using the network coded combined message instead of waiting for separate retransmissions associated with each of the sidelink messages, which may reduce retransmission times, improve retransmission efficiency, and reduce overall latency. In some examples, communicating groupcast retransmissions via network coded combined messages may reduce signaling overhead between UEs, increase coordination between communication devices, and increase battery life, among other benefits.

Aspects of the disclosure are initially described in the context of wireless communications systems. Aspects of the disclosure are then discussed with reference to algorithmic retransmission schemes and a process flow. Aspects of the disclosure are further illustrated by and described with reference to apparatus diagrams, system diagrams, and flowcharts that relate to network coding in v2x for UEs with different storage sizes.

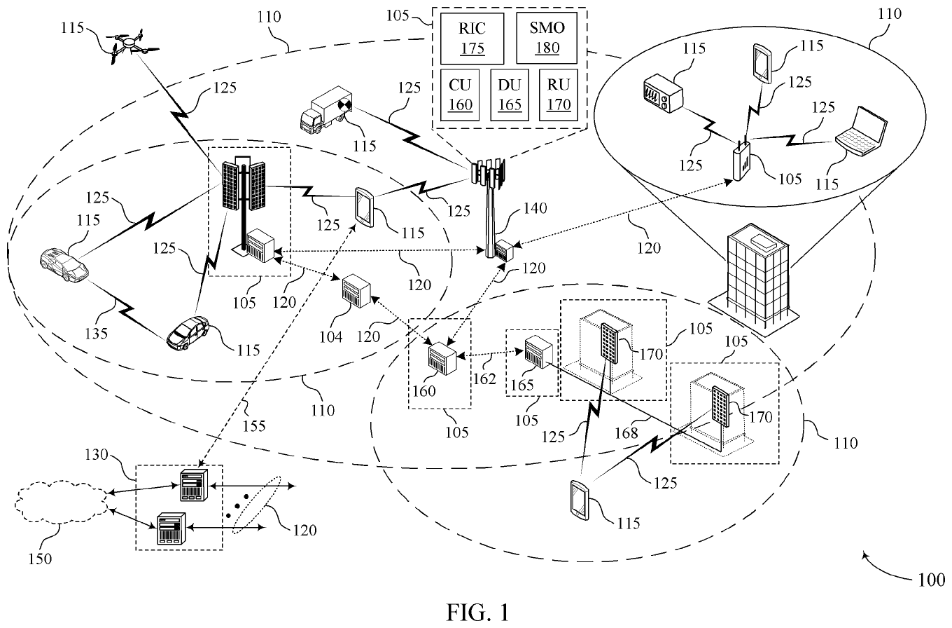

FIG. 1 illustrates an example of a wireless communications system 100 that supports techniques for network coding based on device storage in accordance with various aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for network coding based on device storage as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may include or be an example of a sidelink network, in which UEs 115 or other devices may communicate via sidelink communication links. For example, a sidelink network may include or be an example of a V2X network and may include roadside units (RSUs), vehicle UEs 115, or the like, among other examples. In some cases, one or more devices (e.g., UEs 115, RSUs, etc.) in the sidelink network may act as a relay node, such as a UE-to-UE relay node, a UE-to-Network (U2N) relay node, or the like. A relay node may provide connectivity to the network for other UEs 115, such as remote UEs 115, by relaying messages (e.g., control signaling, data signaling) to and from the remote UEs 115. For example, a relay node may provide or support multi-hop communication paths to enable a remote UE 115 that is out of coverage of a network entity 105 to communicate with the network entity 105. In UE-to-UE relay, the relay node may be an example of a UE 115 that acts as a relay between a source UE 115 and a target UE 115. For instance, a relay UE 115 may provide a communication path between the source UE 115 and the target UE 115, which, in some examples, may both be remote UEs 115. In some cases, the relay UE 115 may use layer 2 or layer 3 relaying (e.g., in accordance with a layer 2 relay architecture or a layer 3 relay architecture, respectively). Relay techniques including UE-to-UE relaying may be useful for proximity-based applications such as proximity services (ProSe).

Additionally, or alternatively, the wireless communications system 100 may support groupcast communications between a group of UEs 115, e.g., in a sidelink network. For example, a UE 115 may transmit (e.g., broadcast) a same groupcast sidelink message to each UE 115 of the group of UEs 115. Each UE 115 receiving the groupcast sidelink message may transmit feedback information (e.g., HARQ feedback information, ACK, NACK, etc.) for the groupcast sidelink message to the UE 115. In some cases, the UE 115 may retransmit the groupcast sidelink message, e.g., based on the feedback information. That is, some feedback information (e.g., NACK) may indicate a request for retransmission of the groupcast sidelink message.

For example, if a receiving UE 115 fails to receive or decode all or a portion of a groupcast sidelink message, the receiving UE 115 may transmit a NACK to the UE 115 that transmitted the groupcast sidelink message (e.g., a transmitting UE 115). The NACK may indicate that the receiving UE 115 is requesting retransmission of the groupcast sidelink message. In some cases, the receiving UE 115 may store information associated with the groupcast sidelink message at the receiving UE 115, such as all or a portion of decoded data from the groupcast sidelink message. The transmitting UE 115 may receive the NACK and may retransmit the groupcast sidelink message to the receiving UE 115. The receiving UE 115 may recover the portion(s) of the groupcast sidelink message that were not successfully decoded using the retransmission. For example, the receiving UE 115 may extract a set of code blocks corresponding to unsuccessfully decoded code blocks from the initial transmission of the groupcast sidelink message using logarithmic likelihood ratios (LLRs) and HARQ combination techniques.

However, such retransmissions may increase congestion and signaling overhead, increase power consumption, and increase latency in the sidelink network. For example, if multiple UEs 115 of the group of UEs 115 fail to receive the groupcast sidelink message, the transmitting UE 115 may retransmit the groupcast sidelink message to each of the multiple UEs 115.

As such, various aspects of the techniques described herein support using network coding-based retransmission, which may improve retransmission efficiency and reduce retransmission times. A transmitting device, which may be an example of a relay node (e.g., a relay UE 115, a relay RSU, or the like), may apply network coding techniques to generate a combined retransmission message that includes information associated with (e.g., received via) one or more sidelink messages. For example, the transmitting device may receive a set of sidelink messages and corresponding feedback information from UEs 115 in a group of UEs 115. The transmitting device may combine a subset (e.g., two or more) of the sidelink messages using an exclusive or (XOR) operation to obtain a network coded combined message corresponding to the subset of sidelink messages. For example, the subset of sidelink messages may include sidelink messages associated with negative feedback information (e.g., NACK) or otherwise indicating a requested retransmission.

In some cases, the transmitting device may generate multiple network coded combined messages. For example, the transmitting device may determine a minimum quantity of network coded combined messages that supports reception of all requested retransmissions at the group of UEs 115. Here, the transmitting device may generate a first matrix based on the feedback information for the set of sidelink messages, where values of the first matrix indicate which sidelink messages are associated with a requested retransmission. The first matrix may also indicate which UEs 115 of the group of UEs 115 requested retransmission of each sidelink message. The transmitting device may determine the subset of sidelink messages using the first matrix.

The transmitting device may generate a second matrix based on storage capabilities of each UE 115 of the group of UEs 115. The transmitting device may perform an operation to reduce the rank of the second matrix, for example, based on any overlap between requested retransmissions from different UEs 115 (e.g., based on two or more UEs 115 requesting retransmission of a same sidelink message). The transmitting device may obtain a third matrix corresponding to the rank-reduced second matrix. The third matrix may indicate the minimum quantity of network coded combined messages may be used to transmit all of the requested retransmissions. Additionally, the third matrix may indicate which sidelink messages of the subset of sidelink messages may be transmitted in a respective network coded combined message.

The transmitting device may generate the network coded combined messages based on the matrices. For example, based on the third matrix, the transmitting device may generate a first network coded combined message corresponding to a first subset of sidelink messages and a second network coded combined message corresponding to a second subset of sidelink messages. The transmitting device may transmit the network coded combined messages to the group of UEs 115. A receiving UE 115 may use the network coded combined messages and any decoded data associated with the set of sidelink messages stored at the receiving UE 115 to recover or otherwise extract a full sidelink message that the receiving UE 115 may have previously failed to decode.

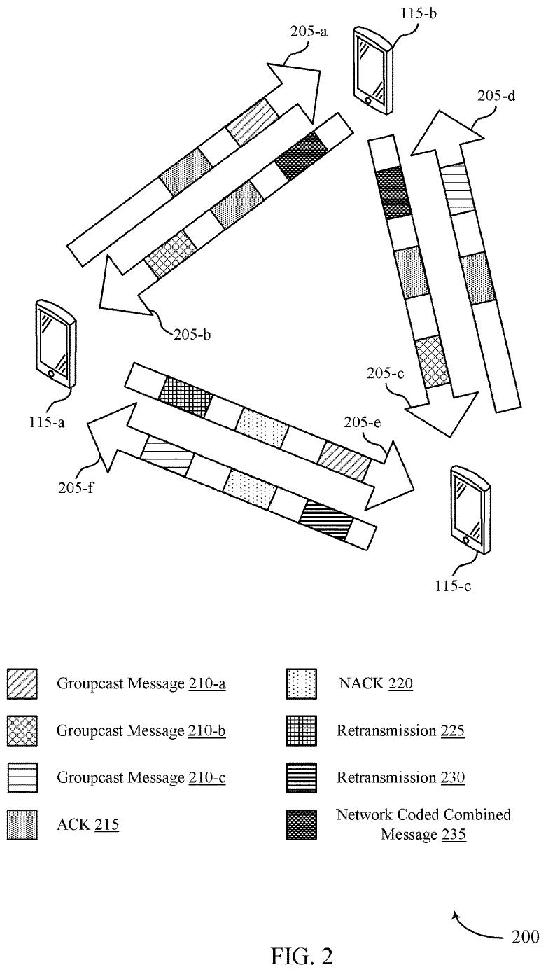

FIG. 2 illustrates an example of a wireless communications system 200 that supports techniques for network coding based on device storage in accordance with various aspects of the present disclosure. The wireless communications system 200 may implement aspects of the wireless communications system 100 or may be implemented by aspects of the wireless communications system 100. For example, the wireless communications system 200 may include a UE 115-a, a UE 115-b, and a UE 115-c, which may be examples of the corresponding devices described with reference to FIG. 1. In some examples, one or more of the UEs 115 may be an example of a relay node (e.g., may operate according to a relay scheme). It is noted that, while examples of some quantities of devices and types of devices are described herein, any quantity of devices and device types may support the techniques described in the present disclosure.

The wireless communications system 200 may support sidelink communications between the UEs 115 over various sidelinks 205, which may be examples of communication links 125 or D2D communication links 135 as described with reference to FIG. 1. For example, the UE 115-a may transmit sidelink messages to the UE 115-b via a sidelink 205-a and to the UE 115-c via a sidelink 205-e. Additionally, the UE 115-a may receive sidelink messages from the UE 115-b via a sidelink 205-b and from the UE 115-c via a sidelink 205-f. The UE 115-c may transmit sidelink messages to the UE 115-b via a sidelink 205-d and may receive sidelink messages from the UE 115-b via a sidelink 205-c. In some examples, the sidelinks 205 may include or be examples of a physical sidelink channel such as a PSSCH, a PSCCH, or a PSFCH, among other examples of physical sidelink channels.

The UEs 115 in the wireless communications system 200 may belong to a UE group (e.g., a group of UEs 115) and may support groupcast sidelink communications between the UEs 115 in the UE group. For example, each UE 115 may transmit a groupcast message 210 to the other UEs 115 in the UE group via the sidelinks 205, where each groupcast message 210 may be a same message (e.g., having a same payload) that is transmitted (e.g., broadcasted) to the other UEs 115. Groupcasting a message may enable any UEs 115 in the group to receive the message, e.g., without transmitting the message to each UE 115 individually.

Additionally, the UEs 115 may utilize retransmission schemes to improve reliability of groupcast communications. Some retransmission schemes may include multiple transmission phases representative of a transmission occurring during the corresponding transmission phase. A UE 115, such as the UE 115-a, may transmit an initial transmission of a groupcast message 210, such as a groupcast message 210-a, during an initial transmission phase. In some examples, the initial transmission phase may also include communication of feedback information. A UE 115 receiving the groupcast message 210-a, such as the UE 115-c, may transmit, to the UE 115-a, feedback information for the groupcast message 210-a. The feedback information may include HARQ-ACK feedback (e.g., ACK/NACK feedback) that indicates whether the UE 115-c successfully received and decoded the groupcast message 210-a and, in some cases, whether the UE 115-c requests a retransmission of the groupcast message 210-a. For instance, the UE 115-c may transmit a NACK 220 to indicate that the UE 115-c failed to receive or decode the groupcast message 210-c and that the UE 115-c is requesting retransmission of the groupcast message 210-c. In some examples, the UE 115-c may groupcast the NACK 220.

In a retransmission phase, and based on receiving the NACK 220, the UE 115-a may transmit a retransmission 225 to the UE 115-c, where the retransmission 225 corresponds to the groupcast message 210-a (e.g., the retransmission 225 includes the same information or data as the groupcast message 210-a). In some examples, the UE 115-a may groupcast the retransmission 225. The UE 115-c may attempt to decode the retransmission 225 to obtain the information or data. In general, retransmissions may increase reliability of groupcast messages 210 such as the groupcast message 210-a, e.g., by providing additional opportunities for the UE 115-c to receive and decode information or data included in the groupcast message 210-a.

In some cases, the UE 115-c may utilize the retransmission 225 to recover portions of the initial transmission of the groupcast message 210-a. For example, the UE 115-c may have successfully decoded one or more portions (e.g., code blocks) of the initial transmission of the groupcast message 210-a, but may have failed to decode other portions. The UE 115-c may store some or all of the information received or decoded from the initial transmission at the UE 115-c. In some cases, the UE 115-c may store data corresponding to successfully decoded portions of the initial transmission, data corresponding to unsuccessfully decoded portions of the initial transmission, or a combination thereof. Data stored at the UE 115-c may depend on a storage capability of the UE 115-c. In some examples, the UE 115-c may be capable of storing one or more full messages received at the UE 115-c, while in other examples, the UE 115-c may have a limited storage capacity and may only store portions of the one or more messages.

Based on receiving the retransmission 225, the UE 115-c may combine the stored information with information included in the retransmission 225 to obtain a full set of information corresponding to the groupcast message 210-a. For example, the UE 115-c may extract a set of code blocks corresponding to unsuccessfully decoded information from the initial transmission based on combining the stored information and the retransmission 225. In some cases, the UE 115-c may generate a set of LLRs associated with the retransmission 225 and may utilize HARQ combination techniques based on the set of LLRs to recover the set of code blocks and obtain the full set of information.

FIG. 2 illustrates an example of groupcast transmission and retransmission for the UE group. The UE 115-a may transmit the groupcast message 210-a to the UE 115-b and the UE 115-c. The UE 115-b may transmit a groupcast message 210-b to the UE 115-c and the UE 115-a, and the UE 115-c may transmit a groupcast message 210-c to the UE 115-a and the UE 115-b. The UE 115-a and the UE 115-c may both successfully receive (e.g., decode) the groupcast message 210-b from the UE 115-b, and may each transmit an ACK 215 to the UE 115-b. The UE 115-b may successfully receive (e.g., decode) the groupcast message 210-a from the UE 115-a and the groupcast message 210-c from the UE 115-c, and may transmit ACKs 215 to the UE 115-a and the UE 115-c.

However, the UE 115-c may fail to decode the groupcast message 210-a from the UE 115-a, and the UE 115-a may fail to decode the groupcast message 210-c from the UE 115-c. In an example retransmission scheme, the UE 115-c may transmit a NACK 220 to the UE 115-a requesting retransmission of the groupcast message 210-a. Based on receiving the NACK 220, the UE 115-a may transmit a retransmission 225 to the UE 115-c. Additionally, the UE 115-a may transmit a NACK 220 to the UE 115-c. The NACK 220 may request retransmission of the groupcast message 210-c. Accordingly, the UE 115-c may transmit a retransmission 230 to the UE 115-a. The UE 115-a and the UE 115-c may continue to transmit feedback information and retransmissions until each UE 115 has successfully decoded the groupcast messages 210.

In some cases, however, this retransmission scheme may be associated with relatively high latency and signaling overhead. For example, the UE 115-a may have to wait for a time duration corresponding to a transmission time of the NACK 220 transmitted by the UE 115-a and a transmission time of the retransmission 230 received from the UE 115-c before successfully decoding and obtaining information included in the groupcast message 210-c. If the UE 115-a fails to successfully decode the retransmission 230, this time duration may increase, as the UE 115-a may transmit an additional NACK 220 and wait to receive a second retransmission 230. Further, because a NACK 220 and a retransmission (e.g., retransmission 225, retransmission 230) are communicated for every failed decoding attempt, resource usage and signaling overhead may be relatively high. The sidelinks 205-e and 205-f may thus experience significant congestion, which may increase interference and collisions.

To improve retransmission efficiency, reduce resource usage, and avoid congestion, the UE group may utilize a network coding-based retransmission scheme in accordance with the techniques described herein. A UE 115 in the UE group may be associated with a relatively high reliability and may be referred to as a reliable UE, where the UE 115 may be capable of receiving and decoding transmissions with a relatively high likelihood of success. For example, the UE 115 may be an example of (e.g., operate as) a relay node, such as a relay UE. Additionally, or alternatively, the wireless communications system 200 may be an example of a V2X system, and the UE 115 may include or be an example of an RSU. In any case, the UE 115 may receive and decode all of the groupcast messages 210. Additionally, the UE 115 may receive feedback information associated with each groupcast message 210, such that the UE 115 is aware of whether an intended recipient of a groupcast message 210 successfully decoded the groupcast message 210. The UE 115 may utilize network coding to combine retransmissions for the groupcast messages 210 into one or more network coded combined messages and may transmit (e.g., groupcast) the one or more network coded combined messages to the other UEs 115 in the UE group.

In some cases, the UE 115 may utilize network coding for retransmissions based on a reliability threshold, which may be associated with one or more groupcast messages 210. Communications between UEs 115 via a sidelink 205 may have relatively high reliability requirements, for instance, as part of quality of service (QoS) requirements associated with a sidelink 205 or with a groupcast message 210. Accordingly, the UE 115 may identify a reliability threshold for one or more groupcast messages 210. If the reliability threshold is satisfied, the UE 115 may combine retransmissions for the groupcast messages 210 using network coding.

Because the UE 115 combines the retransmissions, the one or more network coded combined messages may reduce an overall quantity of retransmissions in the wireless communications system 200, e.g., as compared to each UE 115 transmitting a retransmission (e.g., retransmission 225, retransmission 230) to another UE 115 for each groupcast message 210. As illustrated in FIG. 2, the UE 115-b may be an example of a reliable UE and may successfully decode the groupcast message 210-a and the groupcast message 210-c. The UE 115-b may also receive (e.g., via groupcast) the NACKs 220 corresponding to the groupcast message 210-a and the groupcast message 210-b. Accordingly, the UE 115-b may determine that the UE 115-a failed to receive the groupcast message 210-c and that the UE 115-c failed to receive the groupcast message 210-a. The UE 115-b may generate a network coded combined message 235 corresponding to the groupcast message 210-a and the groupcast message 210-c (e.g., based on the associated NACKs 220) and may transmit (e.g., groupcast) the network coded combined message 235 to the UE 115-a and the UE 115-c via the sidelinks 205-b and 205-c. Thus, the UE 115-c and the UE 115-a may recover the groupcast message 210-a and the groupcast message 210-c, respectively, based on a single message (e.g., the network coded combined message 235) rather than utilizing the individual retransmissions 225 and 230, respectively.

To generate the network coded combined message 235, the UE 115-b may perform an XOR operation on the groupcast message 210-a and the groupcast message 210-c. That is, the UE 115-b may determine information to include in the network coded combined message that corresponds to some or all of the information included in each of the groupcast messages 210 using XOR logic, such that the network coded combined message 235=(the groupcast message 210-a (the groupcast message 210-c). Additionally, the UE 115-b may indicate the groupcast messages 210 that are included in the network coded combined message 235 to the UE 115-a and the UE 115-c. In some examples, the UE 115-b may include the indication in the network coded combined message 235 (e.g., the network coded combined message 235 may include an indication of the groupcast message 210-a and the groupcast message 210-c).

Additionally, or alternatively, the UE 115-b may transmit the indication as part of control signaling, such as sidelink control information (SCI) (e.g., SCI 1, SCI 2). The UE 115-b may transmit SCI scheduling one or more sidelink messages, where the SCI indicates whether the one or more sidelink messages are network coded combined messages. For example, the UE 115-b may transmit SCI scheduling the network coded combined message 235; the SCI may indicate that the network coded combined message 235 is a network coded combined message, and may indicate the groupcast message 210-a and the groupcast message 210-c.

In some examples, the UE 115-b may act as a relay node (e.g., a relay UE). In such examples, the UE 115-b may transmit (e.g., relay) the network coded combined message 235 based on L2 relaying or L3 relaying. The network coded combined message 235 may be associated with an RLC layer, a MAC layer, a PDCP layer, an IP layer, or a combination thereof.

Upon reception of the network coded combined message 235, the UE 115-a and the UE 115-c may recover or otherwise extract information corresponding to unsuccessfully decoded code blocks from the groupcast message 210-c and the groupcast message 210-a, respectively. In some cases, the UE 115-a and the UE 115-c may use LLRs and HARQ combination techniques, for example, utilizing information stored at each UE 115 and the network coded combined message 235.

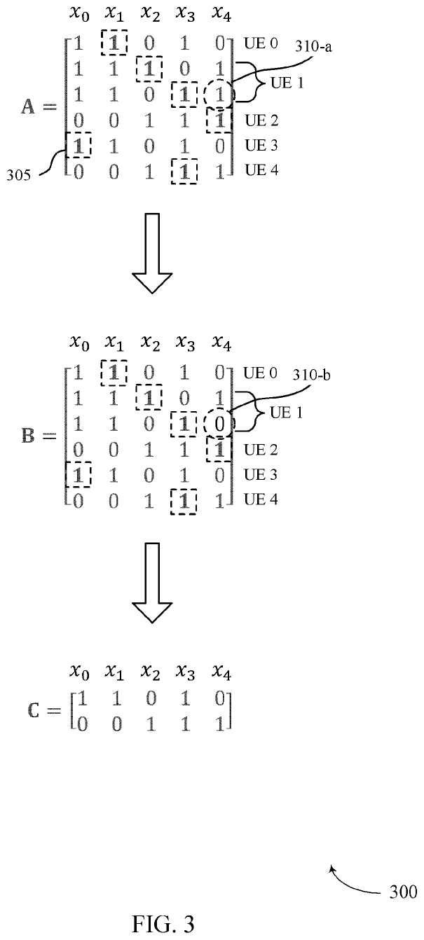

In some examples, the UE 115-b may generate multiple network coded combined messages. For example, as described in greater detail with reference to FIG. 3, the UE group may include additional UEs 115 that communicate additional groupcast messages 210 and corresponding feedback. The UE 115-b may generate a first network coded combined message that corresponds to a first subset of groupcast messages 210 and may generate a second network coded combined message that corresponds to a second subset of groupcast messages 210. Additionally, in some cases, the UE 115-b may apply one or more combining rules to determine a minimum quantity of network coded combined messages to be generated, and to determine which groupcast messages 210 to include in each network coded combined message.

The UE 115-b may additionally consider storage capabilities of each UE 115 of the UE group when determining and generating the one or more network coded combined messages. In some cases, the UE 115-b may receive, from each UE 115, an indication of a storage capability of the respective UE 115. The storage capability may indicate a capability of the UE 115 to store data associated with one or more received messages (e.g., one or more groupcast messages 210). For instance, the storage capability may represent an amount or quantity of data that the UE 115 is able to store at the UE 115. In a first example, the UE 115 may be able to store a set of one or more full groupcast messages 210 received by the UE 115. In this example, the UE 115 may additionally store data associated with a groupcast message 210 transmitted by that UE 115.

In a second example, the UE 115 may have a limited storage capacity or capability and may store one or more portions of groupcast messages 210 received by the UE 115 and one or more portions of a groupcast message 210 transmitted by the UE 115. Here, the UE 115 may store subsets of data corresponding to one or more groupcast messages 210 decoded by the UE 115, one or more subsets of data corresponding to the groupcast message 210 transmitted by the UE 115, or a combination thereof. In some examples, the UE 115 may perform network coding on received groupcast messages 210 and, in some cases, the transmitted groupcast message 210 to obtain the subsets of stored data. The UE 115 may, for example, use XOR logic to combine multiple received groupcast messages 210, such that a subset of stored data=a first received groupcast message 210 ⊕ a second received groupcast message 210. A subset of stored data that includes data from multiple groupcast messages 210 may thus correspond to or be understood as a network coded groupcast message 210 (e.g., a network coded sidelink message) stored at the UE 115.

The UE 115-b may generate the one or more network coded combined messages based on the storage capabilities of one or more of the UEs 115 (e.g., based on indications of respective storage capabilities received from each UE 115). That is, the UE 115-b may consider how much data or information a UE 115 may be capable of storing, which may indicate the data or information to be used by the UE 115 in recombining and recovering data from a retransmission. The UE 115-b may, for example, determine which messages to include in a network coded combined message, determine a quantity of network coded combined messages to generate, or both, as described in greater detail with reference to FIG. 3.

By utilizing the network coding techniques described herein, the UEs 115 in the UE group may communicate groupcast retransmissions more efficiently and with fewer overall messages. That is, the UEs 115 may reduce the quantity of retransmissions communicated via the sidelinks 205, which may reduce link congestion and resource consumption and reduce signaling overhead. Additionally, the UEs 115 may communicate with one another with decreased latency and reduced processing power. Further examples of network coding for groupcast retransmissions are described herein, including with reference to FIG. 3.

FIG. 3 illustrates an example of an algorithmic retransmission scheme 300 that supports techniques for network coding based on device storage in accordance with various aspects of the present disclosure. The algorithmic retransmission scheme 300 may implement or be implemented by one or more aspects of the wireless communications system 100, the wireless communications system 200, or a combination thereof. For example, the algorithmic retransmission scheme 300 may be implemented by a transmitting device, which may be an example of a relay node, an RSU, a UE, or the like, as described with reference to FIGS. 1 and 2. The algorithmic retransmission scheme 300 may be conducted at the transmitting device to generate one or more network coded combined messages as described herein. It is noted that, while examples of some quantities of devices and types of devices are described herein, any quantity of devices and device types may support the techniques described in the present disclosure.

The transmitting device may communicate with a group of UEs via one or more sidelink communication links. The group of UEs may include a quantity of UEs that communicate with one another and with the transmitting device. In some examples, the transmitting device may be a UE of the quantity of UEs and belonging to the group of UEs. As described with reference to FIG. 2, each UE may transmit and receive sidelink messages and may additionally communicate feedback information (e.g., ACK/NACK feedback) for each sidelink message. A NACK corresponding to a sidelink message may indicate that the UE transmitting the NACK is requesting retransmission of the sidelink message. The transmitting device may perform retransmission of the requested sidelink messages via one or more network coded combined messages. That is, the transmitting device may generate (e.g., according to the algorithmic retransmission scheme 300) one or more network coded combined messages corresponding to sidelink messages for which one or more UEs have requested retransmission (or otherwise indicated negative feedback information), where the one or more network coded combined messages include the retransmission(s) of the sidelink messages, and may transmit the one or more network coded combined messages to the group of UEs via the sidelink communication links.

For example, each UEᵢ may transmit a sidelink message x₁ (e.g., via groupcast), such that one or more of the other UEs in the group of UEs and the transmitting device may receive and attempt to decode multiple sidelink messages. In the example of FIG. 3, the transmitting device may communicate with five UEs (e.g., i=5). A UE 0 may transmit a sidelink message x₀, a UE 1 may transmit a sidelink message x₁, a UE 2 may transmit a sidelink message x₂, a UE 3 may transmit a sidelink message x₃, and a UE 4 may transmit a sidelink message x₄. Each UE and the transmitting device may receive one or more of the sidelink messages from the other UEs in the group. Additionally, each UE may transmit respective feedback information corresponding to each received sidelink message. The transmitting device may receive the feedback information from each UE.

Based on receiving respective feedback messages from each of the UEs, the transmitting device may operate in accordance with the techniques of algorithmic retransmission scheme 300 to determine the contents of encoded data for retransmission via one or more network coded combined messages as described herein. The retransmission algorithm described in the context of FIG. 3 may utilize one or more sidelink messages for which at least one UE transmitted a NACK and one or more sidelink messages for which at least one UE transmitted an ACK. For example, if a given sidelink message was decoded by all UEs in the group, the transmitting device may no longer consider the sidelink message for the one or more network coded combined messages. Additionally, the retransmission algorithm may depend on (e.g., consider) the storage capabilities of each UE in the group. FIG. 3 may illustrate an example in which the UEs have relatively unlimited storage capabilities, e.g., may be capable of storing a relatively large quantity of sidelink messages (e.g., data associated with sidelink messages, such as initial transmissions, retransmissions, or network coded combined messages). The transmitting device may generate the one or more network coded combined messages according to the retransmission algorithm.

In the example of FIG. 3, each UEᵢ may transmit the corresponding sidelink message xᵢ to one or more intended recipient UEs of the group as shown in Table 1. The transmitting device may receive and successfully decode all of the sidelink messages. Transmission of the sidelink messages may occur during an initial transmission phase.

TABLE 1

| | Transmitted | |
|---|---|---|
| Transmitting | Sidelink | Intended |
| UE | Message | Recipient(s) |
| UE 0 | x₀ | UE 1, UE 3 |
| UE 1 | x₁ | UE 0, UE 3 |
| UE 2 | x₂ | UE 1, UE 4 |
| UE 3 | x₃ | UE 0, UE 1, |
| | | UE 2, UE 4 |
| UE 4 | x₄ | UE 1, UE 2 |

Each UE may receive and attempt to decode the sidelink messages x in accordance with Table 1, and may transmit feedback information accordingly, e.g., indicating whether each UE successfully decoded each sidelink message x. A UE may transmit an ACK to indicate that a corresponding sidelink message was successfully decoded by the UE, and may transmit a NACK corresponding to a sidelink message to indicate a failed decoding attempt and a requested retransmission of the sidelink message. Additionally, each UE may store data (e.g., decoded data) corresponding to successfully decoded sidelink messages and may store data corresponding to the sidelink message transmitted by that UE. Table 2 illustrates feedback information and stored data for the UEs in the example of FIG. 3.

TABLE 2

| | NACKed | |
|---|---|---|
| Transmitting | Sidelink | |
| UE | Message | Stored Data |
| UE 0 | x₁ | x₀ x₃ |
| UE 1 | x₂ x₃ | x₀ x₁ x₄ |
| UE 2 | x₄ | x₂ x₃ |
| UE 3 | x₀ | x₁ x₃ |
| UE 4 | x₃ | x₂ x₄ |

The transmitting device may receive the feedback information for the sidelink messages and may determine or otherwise identify which sidelink messages have been successfully decoded by each UE, and which sidelink messages have not been successfully decoded by each UE. The transmitting device may generate the one or more network coded combined messages based on the feedback information and the retransmission algorithm illustrated by FIG. 3. For example, the transmitting device may create (e.g., generate) a first matrix (e.g., matrix A) representing the sidelink messages transmitted to each UE. Each column vector of the matrix A may correspond to a respective sidelink message xᵢ, while each row vector of the matrix A may correspond to a respective UEᵢ. In some examples, multiple row vectors may correspond to a same UE. The transmitting device may assign a first set of values (e.g., first values) to the matrix A where a value of ‘1’ at an index of the matrix A indicates that the UEᵢ corresponding to the row vector of the index is associated with (e.g., transmitted or received) the sidelink message xᵢ corresponding to the column vector of the index. A value of ‘0’ may indicate that the corresponding UEᵢ is not associated with the corresponding sidelink message xᵢ, e.g., the corresponding UEᵢ was not an intended recipient of the sidelink message xᵢ, nor did the corresponding UEᵢ transmit the sidelink message xᵢ.

The transmitting device may generate the matrix A based on the sidelink messages associated with feedback information requesting retransmission (e.g., NACKs), such that a quantity of columns of the matrix A corresponds to a quantity of NACKs received by the transmitting device for the sidelink messages. The transmitting device may determine a group of sidelink messages that includes the sidelink messages associated with a requested retransmission. In the example of FIG. 3, the group of sidelink messages may include all of the sidelink messages x₀ through x₄, because at least one UE of the group of UEs has indicated a NACK for each of the sidelink messages x₀ through x₄. As illustrated, the group of sidelink messages may be indicated by marked entries 305 in the matrix A, where a marked entry 305 indicates that the UEᵢ corresponding to the row vector of the index has requested retransmission (e.g., NACK) of the sidelink message xᵢ corresponding to the column vector of the index. That is, for each row vector corresponding to a UE, the transmitting device may mark an index to be a marked entry 305 if the UE has requested retransmission of the sidelink message. Accordingly, in the matrix A, an index having a value of 1 that is not a marked entry 305 may indicate that the UE has obtained and stored data of the corresponding sidelink message xᵢ, e.g., the UE has either successfully received and decoded the sidelink message and stored the decoded data, or the UE transmitted the sidelink message and stored the data. Put another way, an index having a value of 1 that is not a marked entry 305 may indicate that the corresponding sidelink message xᵢ is stored at the respective UE (e.g., corresponding to the row vector).

Based on the group of sidelink messages and the matrix A, the transmitting device may determine or otherwise identify one or more subsets of sidelink messages of the group of sidelink messages, where a subset of sidelink messages may correspond to a network coded combined message to be generated by the transmitting device. The transmitting device may determine the one or more subsets of sidelink messages based on the source UE of the NACK for each sidelink message. In some examples, the transmitting device may determine a minimum quantity of network coded combined messages to be generated based on the one or more subsets of sidelink messages.

The transmitting device may perform a rank reduction operation to reduce the rank of matrix A and obtain (i.e., generate) a second matrix (e.g., matrix B). Matrix A may have a rank of 3 and matrix B may have a rank of 2. The rank of matrix B may be equal to a minimum quantity of network coded combined messages to be generated and transmitted by the transmitting device. That is, the rank of matrix B may represent the fewest network coded combined messages that may be transmitted to the UE group to provide all of the requested retransmissions. In some cases, the transmitting device may reduce the rank of matrix A and generate the matrix B by adjusting one or more values of the matrix A, e.g., based on the feedback information.

For example, if a UE has requested retransmission of more than one sidelink message, the transmitting device may generate matrix A to include a row vector for each of the more than one sidelink messages. As such, each UE may have an associated quantity of row vectors equal to the quantity of NACKed sidelink messages. In the example of FIG. 3, because the UE 1 requested retransmission for both the sidelink message x₂ and the sidelink message x₃, the matrix A includes a first row vector for the UE 1 with a marked entry 305 indicating a request for retransmission of the sidelink message x₂ and second row vector for the UE 1 with a marked entry 305 indicating a request for retransmission of the sidelink message x₃. To reduce the rank of matrix A, the transmitting device may adjust a value of an index in each row vector, such as an index corresponding to a sidelink message for which the UE 1 has requested retransmission but that is not a marked entry 305. In the first row vector for the UE 1, the marked entry 305 corresponds to the sidelink message x₂, and the transmitting device may set a value of the index corresponding to the sidelink message x₃ to 0. In the second row vector for the UE 1, the marked entry 305 corresponds to the sidelink message x₃, and the transmitting device may set a value of the index corresponding to the sidelink message x₂ to 0.

Additionally, or alternatively, the transmitting device may adjust values of one or more indexes of the matrix A corresponding to sidelink messages for which a UE has not requested retransmission. For example, the transmitting device may determine, based on the feedback information, that the UE 1 has successfully received and decoded the sidelink message x₄, such that a corresponding index 310-a in the matrix A has a value of 1 and is not a marked entry 305. To reduce the rank of matrix A, the transmitting device may set the value of the index 310-a to 0, as the UE 1 has not requested retransmission of the sidelink message x₄. The transmitting device may generate the matrix B based on adjusting the one or more values of the matrix A, such that the matrix B has a value of 0 for a corresponding index 310-b.

The transmitting device may determine or otherwise identify a row basis of matrix B. In some cases, the transmitting device may generate a third matrix, matrix C, based on (e.g., corresponding to) the row basis of the matrix B. The matrix C may be used to construct the one or more network coded combined messages by encoding data corresponding to the sidelink messages for which the UEs have requested retransmission. For example, the transmitting device may identify the one or more subsets of sidelink messages based on the matrix C, where two or more sidelink messages of a subset of sidelink messages may be combined to generate a network coded combined message (e.g., the network coded combine message may include a combination of the contents of the two or more sidelink messages). More specifically, a first row vector of the matrix C may indicate a first subset of sidelink messages (e.g., of the group of sidelink messages) for a first network coded combined message, and a second row vector of the matrix C may indicate a second subset of sidelink messages (e.g., of the group of sidelink messages) for a second network coded combined message.

The transmitting device may combine the contents of the sidelink messages included in the first subset of sidelink messages using XOR logic (e.g., using network coding). In the example of FIG. 3, the transmitting device may perform an XOR operation on the sidelink message x₀, the sidelink message x₁, and the sidelink message x₃, e.g., as indicated by the first row vector of the matrix C, to obtain the first network coded combined message (e.g., the first network coded combined message=the sidelink message x₀ ® the sidelink message x₁ (the sidelink message x₃). Based on the second row vector of the matrix C, the transmitting device may perform an XOR operation on the sidelink message x₂, the sidelink message x₃, and the sidelink message x₄ to obtain the second network coded combined message (e.g., the second network coded combined message=the sidelink message x₂ ® the sidelink message x₃ (the sidelink message x₄).

The transmitting device may transmit the first network coded combined message and the second network coded combined message to the UEs in the group of UEs. Additionally, in some cases, the transmitting device may indicate the respective sidelink messages (e.g., the subset of sidelink messages) associated with each network coded combined messages. For example, the transmitting device may include one or more rows of the matrix C in a network coded combined message to indicate the sidelink messages for which information has been included in the network coded combined message. In the example of FIG. 3, the transmitting device may include an indication of the first row vector of the matrix C in the first network coded combined message and an indication of the second row vector of the matrix C in the second network coded combined message.

In some examples, the transmitting device may groupcast the first network coded combined message and the second network coded combined message such that every UE in the group of UEs may receive both network coded combined messages. In other examples, the transmitting device may transmit each network coded combined message to the UEs that requested retransmission of one or more sidelink messages included in the respective network coded combined message. Here, the transmitting device may transmit the first network coded combined message to the UE 0, the UE 1, the UE 3, and the UE 4. The transmitting device may transmit the second network coded combined message to the UE 1, the UE 2, and the UE 4.

A receiving UE may utilize the first network coded combined message or the second network coded combined message to recover or extract information associated with one or more sidelink messages that the UE previously failed to decode. For example, the UE may utilize recombining techniques (e.g., HARQ recombining techniques) to combine data stored at the UE with data received in a network coded combined message and obtain data associated with a previously unsuccessfully decoded sidelink message. For example, a UE may recombine (e.g., perform an XOR operation using) a network coded sidelink message stored at the UE with a network coded combined message, or may recombine (e.g., perform an XOR operation using) a stored sidelink message with a network coded combined message, and may extract data corresponding to a previously unsuccessfully decoded sidelink message.

As a specific example, the UE 0 may have successfully decoded the sidelink message x₃, but may have failed to decode the sidelink message x₁. The UE 0 may store, at the UE 0, the decoded sidelink message x₃ and data associated with the sidelink message x₀(e.g., transmitted by the UE 0). The UE 0 may receive the first network coded combined message corresponding to x₀Γx₁Γx₃. The UE 0 may perform an XOR operation on the first network coded combined message, the sidelink message x₃, and the sidelink message x₀ to extract data corresponding to the sidelink message x₁.

Applying network coding to generate combined messages for retransmission of sidelink messages as described in the present disclosure may reduce signaling overhead, resource consumption, and latency. In the example of FIG. 3, when five sidelink messages are associated with requested retransmissions, the transmitting device may transmit two network coded combined messages, where other retransmission schemes may use at least five retransmissions (e.g., one retransmission per sidelink message). As such, the transmitting device and the UEs may use the sidelink channels less frequently, avoiding channel congestion and link degradation. Additionally, fewer retransmissions may reduce processing power and power consumption, improve spectral efficiency of the system, and improve reliability.

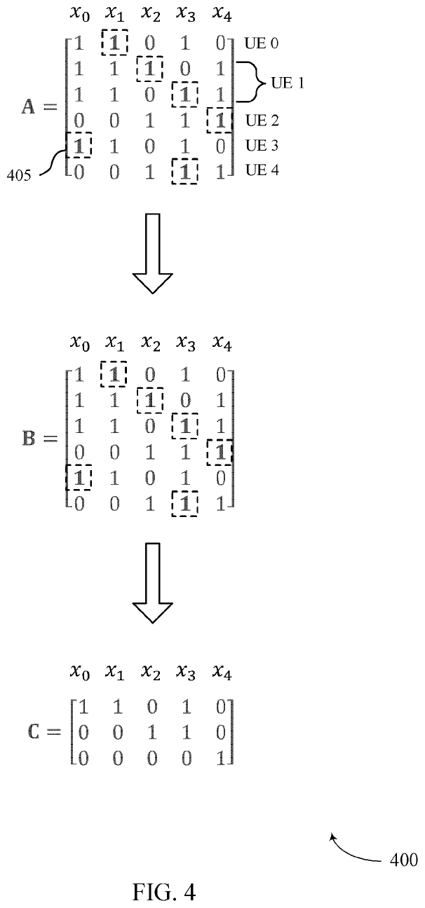

FIG. 4 illustrates an example of an algorithmic retransmission scheme 400 that supports techniques for network coding based on device storage in accordance with various aspects of the present disclosure. The algorithmic retransmission scheme 400 may implement or be implemented by one or more aspects of the wireless communications system 100, the wireless communications system 200, or a combination thereof. For example, the algorithmic retransmission scheme 400 may be implemented by a transmitting device, which may be an example of a relay node, an RSU, a UE, or the like, as described with reference to FIGS. 1 and 2. The algorithmic retransmission scheme 400 may be conducted at the transmitting device to generate one or more network coded combined messages as described herein. It is noted that, while examples of some quantities of devices and types of devices are described herein, any quantity of devices and device types may support the techniques described in the present disclosure.

The transmitting device may communicate with a group of UEs via one or more sidelink communication links. The group of UEs may include a quantity of UEs that communicate with one another and with the transmitting device. In some examples, the transmitting device may be a UE of the quantity of UEs and belonging to the group of UEs. As described with reference to FIGS. 2 and 3, each UE may transmit and receive sidelink messages and may additionally communicate feedback information (e.g., ACK/NACK feedback) for each sidelink message. A NACK corresponding to a sidelink message may indicate that the UE transmitting the NACK is requesting retransmission of the sidelink message. The transmitting device may perform retransmission of the requested sidelink messages via one or more network coded combined messages. That is, the transmitting device may generate (e.g., according to the algorithmic retransmission scheme 400) one or more network coded combined messages corresponding to sidelink messages for which one or more UEs have requested retransmission (or otherwise indicated negative feedback information), where the one or more network coded combined messages include the retransmission(s) of the sidelink messages, and may transmit the one or more network coded combined messages to the group of UEs via the sidelink communication links.

For example, each UEᵢ may transmit a sidelink message xᵢ (e.g., via groupcast), such that one or more of the other UEs in the group of UEs and the transmitting device may receive and attempt to decode multiple sidelink messages. In the example of FIG. 4, the transmitting device may communicate with five UEs (e.g., i=5). A UE 0 may transmit a sidelink message x₀, a UE 1 may transmit a sidelink message x₁, a UE 2 may transmit a sidelink message x₂, a UE 3 may transmit a sidelink message x₃, and a UE 4 may transmit a sidelink message x₄. Each UE and the transmitting device may receive one or more of the sidelink messages from the other UEs in the group. Additionally, each UE may transmit respective feedback information corresponding to each received sidelink message. The transmitting device may receive the feedback information from each UE.

In some examples, each UE may transmit, to the transmitting device, an indication of a storage capability of the UE, an indication of one or more sidelink messages (e.g., decoded sidelink messages, network coded sidelink messages) stored at the UE, or a combination thereof. For example, each UE may transmit (e.g., to the transmitting device) an indication of a storage capability (e.g., for storing a set of decoded sidelink messages), such as an indication of a quantity of sidelink messages (e.g., decoded sidelink messages, network coded sidelink messages) that the UE is capable of storing. For instance, a UE may indicate a storage capability of two, corresponding to a capability of the UE to store two sidelink messages. Additionally, or alternatively, each UE may transmit an indication of one or more sidelink messages (e.g., decoded sidelink messages, network coded sidelink messages) stored at that UE, e.g., including the sidelink message transmitted by that UE.

In some cases, the indication(s) of the storage capability or the sidelink messages stored at a UE may be included as part of the feedback information. A UE may transmit an ACK for a sidelink message x, where the ACK further indicates that the sidelink message x is stored at the UE (e.g., indicates the sidelink message x that is stored at the UE). Additionally, or alternatively, the ACK may indicate a storage index corresponding to a storage location of the sidelink message x. In some cases, the transmitting device may infer or otherwise determine a storage capability of the UE from the indication of the sidelink message(s) stored at the UE. For example, the UE may indicate, within the ACK, a storage index of 1. Upon receiving the ACK, the transmitting device may determine that the sidelink message x to which the ACK corresponds is stored at the UE. The UE may transmit a second ACK corresponding to a second sidelink message and may indicate a storage index of 2. The transmitting device may determine that the UE is capable of storing two sidelink messages, and that the first sidelink message is stored at a first storage location and the second sidelink message is stored at a second storage location.

A UE may have limited storage capabilities or storage capacities and may not be capable of storing every sidelink message received and decoded by the UE. For example, the UE may have a storage capacity such that the UE is capable of storing an amount of data equivalent to one sidelink message. In scenarios where the UE receives multiple sidelink messages, the UE may store combinations of sidelink messages based on the storage capacity. The UE may perform network coding on two or more sidelink messages to obtain (i.e., generate) a network coded sidelink message, and may store the network coded sidelink message at the UE. In some examples, the two or more sidelink messages may include a sidelink message transmitted by that UE.

When reporting a storage capability, the UE may indicate the sidelink messages included in (e.g., corresponding to) a stored network coded sidelink message. The UE 2, for example, may receive and decode the sidelink message x₂ and the sidelink message x₃. The UE 2 may perform an XOR operation to generate a network coded sidelink message, such that the network coded sidelink message=the sidelink message x₂ ® the sidelink message x₃. The UE 2 may indicate storage of x₂Γx₃ to the transmitting device, in the ACK for the sidelink message x₂, in the ACK for the sidelink message x₃, or a combination thereof.

Based on receiving respective feedback messages from each of the UEs, the transmitting device may operate in accordance with the techniques of algorithmic retransmission scheme 400 to determine the contents of encoded data for retransmission via one or more network coded combined messages as described herein. The retransmission algorithm described in the context of FIG. 4 may utilize one or more sidelink messages for which at least one UE transmitted a NACK and one or more sidelink messages for which at least one UE transmitted an ACK. For example, if a given sidelink message was decoded by all UEs in the group, the transmitting device may no longer consider the sidelink message for the one or more network coded combined messages. Additionally, the retransmission algorithm may depend on (e.g., consider) the storage capabilities of each UE in the group. FIG. 4 may illustrate an example in which the UEs have relatively limited storage capabilities and are able to store an amount of data equivalent to one sidelink message. The transmitting device may generate the one or more network coded combined messages according to the retransmission algorithm.

In the example of FIG. 4, each UEᵢ may transmit the corresponding sidelink message xᵢ to one or more intended recipient UEs of the group as shown in Table 3. The transmitting device may receive and successfully decode all of the sidelink messages. Transmission of the sidelink messages may occur during an initial transmission phase.

TABLE 3

| | Transmitted | |
|---|---|---|
| Transmitting | Sidelink | Intended |
| UE | Message | Recipient(s) |
| UE 0 | x₀ | UE 1, UE 3 |
| UE 1 | x₁ | UE 0, UE 3 |
| UE 2 | x₂ | UE 1, UE 4 |
| UE 3 | x₃ | UE 0, UE 1, |
| | | UE 2, UE 4 |
| UE 4 | x₄ | UE 1, UE 2 |

Each UE may receive and attempt to decode the sidelink messages in accordance with Table 3, and may transmit feedback information accordingly, e.g., indicating whether each UE successfully decoded each sidelink message. Additionally, each UE may store data (e.g., decoded data) corresponding to successfully decoded sidelink messages and data corresponding to the sidelink message transmitted by that UE. Based on the storage capability, each UE may generate a network coded sidelink message by applying network coding to combine two or more sidelink messages (e.g., received sidelink messages, transmitted sidelink messages) using XOR logic and may store data corresponding to the network coded sidelink message. Each UE may transmit an indication of a respective storage capability (and, in some cases, an indication of the sidelink messages corresponding to the stored data) to the transmitting device. Table 4 illustrates feedback information and stored data for the UEs in the example of FIG. 4.

TABLE 4

| | NACKed | |
|---|---|---|
| Transmitting | Sidelink | |
| UE | Message | Stored Data |
| UE 0 | x₁ | x₀ ⊕ x₃ |
| UE 1 | x₂ x₃ | x₀ ⊕ x₁ ⊕ x₄ |
| UE 2 | x₄ | x₂ ⊕ x₃ |
| UE 3 | x₀ | x₁ ⊕ x₃ |
| UE 4 | x₃ | x₂ ⊕ x₄ |

The transmitting device may receive the storage capability indications and the feedback information for the sidelink messages. The transmitting device may determine or otherwise identify which sidelink messages have been successfully decoded by each UE and which sidelink messages have not been successfully decoded by each UE. Additionally, the transmitting device may determine or otherwise identify which sidelink messages (or portions or combination thereof) are stored at each UE. The transmitting device may generate the one or more network coded combined messages based on the feedback information, the storage capabilities, and the retransmission algorithm illustrated by FIG. 4.

For example, the transmitting device may create (e.g., generate) a first matrix (e.g., matrix A) representing the sidelink messages transmitted to each UE. Each column vector of the matrix A may correspond to a respective sidelink message xᵢ, while each row vector of the matrix A may correspond to a respective UEᵢ. In some examples, multiple row vectors may correspond to a same UE. The transmitting device may assign a first set of values (e.g., first values) to the matrix A where a value of ‘1’ at an index of the matrix A indicates that the UEᵢ corresponding to the row vector of the index is associated with (e.g., transmitted or received) the sidelink message xᵢ corresponding to the column vector of the index. A value of ‘0’ may indicate that the corresponding UEᵢ is not associated with the corresponding sidelink message xᵢ, e.g., the corresponding UEᵢ was not an intended recipient of the sidelink message xᵢ, nor did the corresponding UEᵢ transmit the sidelink message xᵢ.

The transmitting device may generate the matrix A based on the sidelink messages associated with feedback information requesting retransmission (e.g., NACKs), such that a quantity of columns of the matrix A corresponds to a quantity of NACKs received by the transmitting device for the sidelink messages. The transmitting device may determine a group of sidelink messages that includes the sidelink messages associated with a requested retransmission. In the example of FIG. 4, the group of sidelink messages may include all of the sidelink messages x₀ through x₄, because at least one UE of the group of UEs has indicated a NACK for each of the sidelink messages x₀ through x₄. As illustrated, the group of sidelink messages may be indicated by marked entries 405 in the matrix A, where a marked entry 405 indicates that the UEᵢ corresponding to the row vector of the index has requested retransmission (e.g., NACK) of the sidelink message xᵢ corresponding to the column vector of the index. That is, for each row vector corresponding to a UE, the transmitting device may determine an index to be a marked entry 405 if the UE has requested retransmission of the sidelink message. Accordingly, in the matrix A, an index having a value of 1 that is not a marked entry 405 may indicate that the UE has obtained and stored data of the corresponding sidelink message xᵢ, e.g., the UE has either successfully received and decoded the sidelink message, or the UE transmitted the sidelink message.

Based on the group of sidelink messages, the feedback information, the storage capabilities, and the matrix A, the transmitting device may determine or otherwise identify one or more subsets of sidelink messages of the group of sidelink messages, where a subset of sidelink messages may correspond to a network coded combined message to be generated by the transmitting device. In some examples, the transmitting device may determine a minimum quantity of network coded combined messages to be generated based on the one or more subsets of sidelink messages. The minimum quantity of network coded combined messages may depend on the storage capabilities of the UEs.

As described with reference to FIG. 3, when the UE 1 is capable of storing one or more full sidelink messages, the transmitting device may set at least one of the two values corresponding to the sidelink message x₄ to be equal to 0, in order to reduce the rank of matrix A and generate matrix B. That is, in the example of FIG. 3, the UE 1 may have stored all of the data corresponding to the sidelink message x₄, so the transmitting device may not include the sidelink message x₄ in a network coded combined message transmitted to the UE 1.

In the example of FIG. 4, however, based on the storage capabilities indicated by the UE 1, the transmitting device may refrain from adjusting any of the values. That is, the transmitting device may not adjust values that would result in a sidelink message being excluded from a network coded combined message, as a limited-storage UE may rely on the sidelink message to perform recombination. In the example of FIG. 4, the UE 1 has stored data corresponding to x₀Γx₁Γx₄, and may utilize the data associated with the sidelink message x₄ when applying recombination techniques. Accordingly, the transmitting device may determine that the matrix A cannot be reduced in rank, and the matrix B may have a same rank (e.g., 3) as the matrix A.

The transmitting device may generate a third matrix, matrix C, based on (e.g., corresponding to) the row basis of the matrix A. The matrix C may be used to construct the one or more network coded combined messages by encoding data corresponding to the sidelink messages for which the UEs have requested retransmission. For example, the transmitting device may identify one or more subsets of sidelink messages based on the matrix C, where the transmitting device combines two or more sidelink messages of a subset of sidelink messages to generate a network coded combined message (e.g., the network coded combine message may include a combination of the contents of the two or more sidelink messages). More specifically, a first row vector of the matrix C may indicate a first subset of sidelink messages (e.g., of the group of sidelink messages) for a first network coded combined message, a second row vector of the matrix C may indicate a second subset of sidelink messages (e.g., of the group of sidelink messages) for a second network coded combined message, a third row vector of the matrix C may indicate a third subset of sidelink messages (e.g., of the group of sidelink messages) for a third network coded combined message, and so on.

The transmitting device may combine the contents of two or more of the sidelink messages included in each subset of sidelink messages using XOR logic (e.g., using network coding). In the example of FIG. 4, the transmitting device may perform an XOR operation on the sidelink message x₀, the sidelink message x₁, and the sidelink message x₃, e.g., as indicated by the first row vector of the matrix C, to obtain the first network coded combined message (e.g., the first network coded combined message=the sidelink message x₀Γ the sidelink message x₁ (the sidelink message x₃). Based on the second row vector of the matrix C, the transmitting device may perform an XOR operation on the sidelink message x₂ and the sidelink message x₃ to obtain the second network coded combined message (e.g., the second network coded combined message=the sidelink message x₂Γ the sidelink message x₃).

Because the third row of matrix C corresponds to a single sidelink message (e.g., the sidelink message x₄), the transmitting device may not include the sidelink message x₄ in a network coded combined message. Instead, the transmitting device may retransmit the sidelink message x₄ separately.

The transmitting device may transmit the first network coded combined message, the second network coded combined message, and the sidelink message x₄ to the UEs in the group of UEs. Additionally, in some cases, the transmitting device may indicate the respective sidelink messages (e.g., the subset of sidelink messages) associated with each network coded combined messages. For example, the transmitting device may include an indication of the first row vector of the matrix C in the first network coded combined message and an indication of the second row vector of the matrix C in the second network coded combined message.

A receiving UE may utilize the first network coded combined message, the second network coded combined message, and the retransmission of the sidelink message x₄ to recover information associated with one or more sidelink messages that the UE previously failed to decode. For example, a UE may recombine (e.g., perform an XOR operation using) a network coded sidelink message stored at the UE with a network coded combined message, or may recombine (e.g., perform an XOR operation using) a stored sidelink message with a network coded combined message, and may extract data corresponding to a previously unsuccessfully decoded sidelink message.

As a specific example, the UE 0 may have successfully decoded the sidelink message x₃, but may have failed to decode the sidelink message x₁. The UE 0 may have performed an XOR operation on the sidelink message x₃ and the sidelink message x₀ (e.g., transmitted by the UE 0) to obtain a network coded sidelink message corresponding to x₀Γx₃, and may have stored the network coded sidelink message at the UE 0. The UE 0 may receive the first network coded combined message corresponding to x₀Γx₁Γx₃. The UE 0 may perform an XOR operation on the network coded sidelink message and the first network coded combined message to extract data corresponding to the sidelink message x₁.

Applying network coding to generate combined messages for retransmission of sidelink messages as described in the present disclosure may reduce signaling overhead, resource consumption, and latency. In the example of FIG. 4, when five sidelink messages are associated with requested retransmissions, the transmitting device may transmit two network coded combined messages and one retransmission, where other retransmission schemes may use at least five retransmissions (e.g., one retransmission per sidelink message). As such, the transmitting device and the UEs may use the sidelink channels less frequently, avoiding channel congestion and link degradation. Additionally, fewer retransmissions may reduce processing power and power consumption, improve spectral efficiency of the system, and improve reliability.

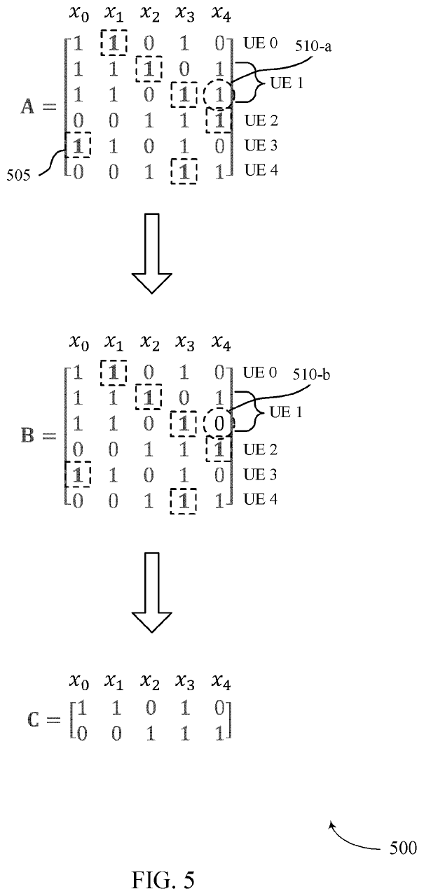

FIG. 5 illustrates an example of an algorithmic retransmission scheme 500 that supports techniques for network coding based on device storage in accordance with various aspects of the present disclosure. The algorithmic retransmission scheme 500 may implement or be implemented by one or more aspects of the wireless communications system 100, the wireless communications system 200, or a combination thereof. For example, the algorithmic retransmission scheme 500 may be implemented by a transmitting device, which may be an example of a relay node, an RSU, a UE, or the like, as described with reference to FIGS. 1 and 2. The algorithmic retransmission scheme 500 may be conducted at the transmitting device to generate one or more network coded combined messages as described herein. It is noted that, while examples of some quantities of devices and types of devices are described herein, any quantity of devices and device types may support the techniques described in the present disclosure.

As described with reference to FIGS. 3 and 4, the transmitting device may communicate with a group of UEs via one or more sidelink communication links by receiving sidelink messages and associated feedback. The transmitting device may generate (e.g., according to the algorithmic retransmission scheme 500) one or more network coded combined messages corresponding to sidelink messages for which one or more UEs have requested retransmission (or otherwise indicated negative feedback information), where the one or more network coded combined messages include the retransmission(s) of the sidelink messages, and may transmit the one or more network coded combined messages to the group of UEs via the sidelink communication links.

In the example of FIG. 5, the transmitting device may communicate with five UEs. A UE 0 may transmit a sidelink message x₀, a UE 1 may transmit a sidelink message x₁, a UE 2 may transmit a sidelink message x₂, a UE 3 may transmit a sidelink message x₃, and a UE 4 may transmit a sidelink message x₄. Each UE and the transmitting device may receive one or more of the sidelink messages from the other UEs in the group. Additionally, each UE may transmit respective feedback information corresponding to each received sidelink message. The transmitting device may receive the feedback information from each UE.

In some examples, each UE may transmit, to the transmitting device, an indication of a storage capability of the UE, an indication of one or more sidelink messages (e.g., decoded sidelink messages, network coded sidelink messages) stored at the UE, or a combination thereof. For example, each UE may transmit (e.g., to the transmitting device) an indication of a storage capability (e.g., for storing a set of decoded sidelink messages), such as an indication of a quantity of sidelink messages (e.g., decoded sidelink messages, network coded sidelink messages) that the UE is capable of storing. For instance, a UE may indicate a storage capability of two, corresponding to a capability of the UE to store two sidelink messages. Additionally, or alternatively, each UE may transmit an indication of one or more sidelink messages (e.g., decoded sidelink messages, network coded sidelink messages) stored at that UE, e.g., including the sidelink message transmitted by that UE.

In some cases, the indication(s) of the storage capability or the sidelink messages stored at a UE may be included as part of the feedback information. A UE may transmit an ACK for a sidelink message x, where the ACK further indicates that the sidelink message x is stored at the UE (e.g., indicates the sidelink message x that is stored at the UE). Additionally, or alternatively, the ACK may indicate a storage index corresponding to a storage location of the sidelink message x. In some cases, the transmitting device may infer or otherwise determine a storage capability of the UE from the indication of the sidelink message(s) stored at the UE. For example, the UE may indicate, within the ACK, a storage index of 1. Upon receiving the ACK, the transmitting device may determine that the sidelink message x to which the ACK corresponds is stored at the UE. The UE may transmit a second ACK corresponding to a second sidelink message and may indicate a storage index of 2. The transmitting device may determine that the UE is capable of storing two sidelink messages, and that the first sidelink message is stored at a first storage location and the second sidelink message is stored at a second storage location.

In some examples, a UE receiving multiple sidelink messages may store combinations of sidelink messages based on the storage capacity of the UE. For example, the UE may perform network coding on two or more sidelink messages to obtain (i.e., generate) a network coded sidelink message, and may store the network coded sidelink message at the UE. In some examples, the two or more sidelink messages may include a sidelink message transmitted by that UE. When reporting a storage capability, the UE may indicate the sidelink messages included in (e.g., corresponding to) a stored network coded sidelink message. The UE 2, for example, may receive and decode the sidelink message x₂ and the sidelink message x₃. The UE 2 may perform an XOR operation to generate a network coded sidelink message, such that the network coded sidelink message=the sidelink message x₂ ® the sidelink message x₃. The UE 2 may indicate storage of x₂Γx₃ to the transmitting device, in the ACK for the sidelink message x₂, in the ACK for the sidelink message x₃, or a combination thereof.

Based on receiving respective feedback messages from each of the UEs, the transmitting device may operate in accordance with the techniques of algorithmic retransmission scheme 500 to determine the contents of encoded data for retransmission via one or more network coded combined messages as described herein. The retransmission algorithm described in the context of FIG. 5 may utilize one or more sidelink messages for which at least one UE transmitted a NACK and one or more sidelink messages for which at least one UE transmitted an ACK. For example, if a given sidelink message was decoded by all UEs in the group, the transmitting device may no longer consider the sidelink message for the one or more network coded combined messages. Additionally, the retransmission algorithm may depend on (e.g., consider) the storage capabilities of each UE in the group. The transmitting device may generate the one or more network coded combined messages according to the retransmission algorithm.

In the example of FIG. 5, each UEᵢ may transmit the corresponding sidelink message xᵢ to one or more intended recipient UEs of the group as shown in Table 5. The transmitting device may receive and successfully decode all of the sidelink messages. Transmission of the sidelink messages may occur during an initial transmission phase.

TABLE 5

| | Transmitted | |
|---|---|---|
| Transmitting | Sidelink | Intended |
| UE | Message | Recipient(s) |
| UE 0 | x₀ | UE 1, UE 3 |
| UE 1 | x₁ | UE 0, UE 3 |
| UE 2 | x₂ | UE 1, UE 4 |
| UE 3 | x₃ | UE 0, UE 1, |
| | | UE 2, UE 4 |
| UE 4 | x₄ | UE 1, UE 2 |

Each UE may receive and attempt to decode the sidelink messages in accordance with Table 5, and may transmit feedback information accordingly, e.g., indicating whether each UE successfully decoded each sidelink message. Additionally, each UE may store data (e.g., decoded data) corresponding to successfully decoded sidelink messages and data corresponding to the sidelink message transmitted by that UE. Based on the storage capability, a UE may store data corresponding to an entire sidelink message, data corresponding to a portion of a sidelink message, or a combination thereof. Additionally, or alternatively, a UE may generate a network coded sidelink message by applying network coding to combine two or more sidelink messages (e.g., received sidelink messages, transmitted sidelink messages) using XOR logic and may store data corresponding to the network coded sidelink message. Each UE may transmit an indication of a respective storage capability (and, in some cases, an indication of the sidelink messages corresponding to the stored data) to the transmitting device, for example, as part of the feedback information. Table 6 illustrates feedback information and stored data for the UEs in the example of FIG. 5.

TABLE 6

| | NACKed | |
|---|---|---|
| Transmitting | Sidelink | |
| UE | Message | Stored Data |
| UE 0 | x₁ | x₀ ⊕ x₃ |
| UE 1 | x₂x₃ | x₀ ⊕ x₁, x₄ |
| UE 2 | x₄ | x₂ ⊕ x₃ |
| UE 3 | x₀ | x₁ ⊕ x₃ |
| UE 4 | x₃ | x₂ ⊕ x₄ |

The transmitting device may receive the storage capability indications and the feedback information for the sidelink messages. The transmitting device may determine or otherwise identify which sidelink messages have been successfully decoded by each UE and which sidelink messages have not been successfully decoded by each UE. Additionally, the transmitting device may determine or otherwise identify which sidelink messages (or portions or combination thereof) are stored at each UE. The transmitting device may generate the one or more network coded combined messages based on the feedback information, the storage capabilities, and the retransmission algorithm illustrated by FIG. 5.

For example, the transmitting device may create (e.g., generate) a first matrix (e.g., matrix A) representing the sidelink messages transmitted to each UE. Each column vector of the matrix A may correspond to a respective sidelink message xᵢ, while each row vector of the matrix A may correspond to a respective UEᵢ. In some examples, multiple row vectors may correspond to a same UE. The transmitting device may assign a first set of values (e.g., first values) to the matrix A where a value of ‘1’ at an index of the matrix A indicates that the UEᵢ corresponding to the row vector of the index is associated with (e.g., transmitted or received) the sidelink message xᵢ corresponding to the column vector of the index. A value of ‘0’ may indicate that the corresponding UEᵢ is not associated with the corresponding sidelink message xᵢ, e.g., the corresponding UEᵢ was not an intended recipient of the sidelink message xᵢ, nor did the corresponding UEᵢ transmit the sidelink message xᵢ.

The transmitting device may generate the matrix A based on the sidelink messages associated with feedback information requesting retransmission (e.g., NACKs), such that a quantity of columns of the matrix A corresponds to a quantity of NACKs received by the transmitting device for the sidelink messages. The transmitting device may determine a group of sidelink messages that includes the sidelink messages associated with a requested retransmission. In the example of FIG. 5, the group of sidelink messages may include all of the sidelink messages x₀ through x₄, because at least one UE of the group of UEs has indicated a NACK for each of the sidelink messages x₀ through x₄. As illustrated, the group of sidelink messages may be indicated by marked entries 505 in the matrix A, where a marked entry 505 indicates that the UEᵢ corresponding to the row vector of the index has requested retransmission (e.g., NACK) of the sidelink message xᵢ corresponding to the column vector of the index. That is, for each row vector corresponding to a UE, the transmitting device may determine an index to be a marked entry 505 if the UE has requested retransmission of the sidelink message. Accordingly, in the matrix A, an index having a value of 1 that is not a marked entry 505 may indicate that the UE has obtained and stored data of the corresponding sidelink message xᵢ, e.g., the UE has either successfully received and decoded the sidelink message and stored the decoded data, or the UE transmitted the sidelink message and stored the data. Put another way, an index having a value of 1 that is not a marked entry 505 may indicate that the corresponding sidelink message xᵢ is stored at the respective UE (e.g., corresponding to the row vector).

For example, the transmitting device may identify one or more indexes of the matrix A indicating that a UE has stored a sidelink message (e.g., has successfully decoded a sidelink message), such as indexes having a value of 1 that are not marked entries 505. In some examples, the transmitting device may determine that two or more values of the matrix A represent a sidelink message stored at a same storage location. For example, because the UE 0 transmitted the sidelink message x₀, the transmitting device may be aware that the UE 0 has stored data associated with the sidelink message x₀. Additionally, the UE 0 may indicate, in feedback information, that the UE 0 has stored data associated with the sidelink message x₃ (e.g., x₀ (x₃) in a first storage location. Accordingly, in the row vector corresponding to the UE 0, a value (e.g., 1) of an index corresponding to the sidelink message x₀ and a value (e.g., 1) of an index corresponding to the sidelink message x₃ may indicate that both sidelink messages are stored at the first storage location.

Based on the group of sidelink messages, the feedback information, storage capability information, stored data information, and the matrix A, the transmitting device may determine or otherwise identify one or more subsets of sidelink messages of the group of sidelink messages, where a subset of sidelink messages may correspond to a network coded combined message to be generated by the transmitting device. In some examples, the transmitting device may determine a minimum quantity of network coded combined messages to be generated based on the one or more subsets of sidelink messages. The minimum quantity of network coded combined messages may depend on the storage capabilities of the UEs.

For example, the minimum quantity of network coded combined messages may be equal to a minimum rank of the matrix A. That is, the minimum rank of matrix A may represent the fewest network coded combined messages that may be transmitted to the UE group to provide all of the requested retransmissions. As illustrated in FIG. 4, the matrix A may have a rank of 3. To determine the minimum quantity, the transmitting device may perform one or more rank reduction operations to reduce the rank of the matrix A and obtain (i.e., generate) a second matrix (e.g., matrix B).

The transmitting device may reduce the rank of the matrix A by adjusting one or more values of the matrix A based on the storage capabilities of one or more UEs, data stored at one or more UEs, or a combination thereof. For example, the transmitting device may determine that two or more indexes of the matrix A having a value of 1 represent a sidelink message stored at a same storage location. The transmitting device may adjust the value of at least one of the indexes, e.g., by setting at least one index to 0, to reduce the rank of the matrix A. In some examples, the transmitting device may reduce the rank of the matrix A by adjusting all values in a given row that indicate sidelink messages stored at a same location from a value of 1 to a value of 0. Additionally, or alternatively, the transmitting device may adjust a value of an index based on an indication that the corresponding UE has stored a full sidelink message and has not requested a retransmission for the sidelink message, e.g., as described with reference to FIG. 3. In any case, the transmitting device may generate the matrix B based on adjusting the one or more values of the matrix A.

For example, based on feedback information indicating that the UE 1 has stored the sidelink message x₄, the indexes of the matrix A (e.g., including the index 510-a) corresponding to the sidelink message x₄ in the row vectors corresponding to the UE 1 may each have a value of 1. The transmitting device may adjust the value of the index 510-a to a value of 0 based on the sidelink message x₄ being stored at the UE 1. The transmitting device may generate the matrix B based on adjusting the value such that the index 510-b has a value of 0. Accordingly, the matrix B may have a rank that is less than the matrix A, e.g., the matrix A may have a rank of 3, while the matrix B may have a rank of 2.

The transmitting device may generate a third matrix, matrix C, based on (e.g., corresponding to) the row basis of the matrix B. The matrix C may be used to construct the one or more network coded combined messages by encoding data corresponding to the sidelink messages for which the UEs have requested retransmission. For example, the transmitting device may identify one or more subsets of sidelink messages based on the matrix C, where the transmitting device combines two or more sidelink messages of a subset of sidelink messages to generate a network coded combined message (e.g., the network coded combine message may include a combination of the contents of the two or more sidelink messages). More specifically, a first row vector of the matrix C may indicate a first subset of sidelink messages (e.g., of the group of sidelink messages) for a first network coded combined message, and a second row vector of the matrix C may indicate a second subset of sidelink messages (e.g., of the group of sidelink messages) for a second network coded combined message.

The transmitting device may combine the contents of two or more of the sidelink messages included in each subset of sidelink messages using XOR logic (e.g., using network coding). In the example of FIG. 5, the transmitting device may perform an XOR operation on the sidelink message x₀, the sidelink message x₁, and the sidelink message x₃, e.g., as indicated by the first row vector of the matrix C, to obtain the first network coded combined message (e.g., the first network coded combined message=the sidelink message x₀ ® the sidelink message x₁ (the sidelink message x₃). Based on the second row vector of the matrix C, the transmitting device may perform an XOR operation on the sidelink message x₂, the sidelink message x₃, and the sidelink message x₄ to obtain the second network coded combined message (e.g., the second network coded combined message=the sidelink message x₂ ® the sidelink message x₃Γ the sidelink message x₄).

The transmitting device may transmit the first network coded combined message and the second network coded combined message to the UEs in the group of UEs. Additionally, in some cases, the transmitting device may indicate the respective sidelink messages (e.g., the subset of sidelink messages) associated with each network coded combined messages. For example, the transmitting device may include an indication of the first row vector of the matrix C in the first network coded combined message and an indication of the second row vector of the matrix C in the second network coded combined message.

A receiving UE may utilize the first network coded combined message and the second network coded combined message to recover information associated with one or more sidelink messages that the UE previously failed to decode. For example, a UE may recombine (e.g., perform an XOR operation using) a network coded sidelink message stored at the UE with a network coded combined message, or may recombine (e.g., perform an XOR operation using) a stored sidelink message with a network coded combined message, and may extract data corresponding to a previously unsuccessfully decoded sidelink message.

As a specific example, the UE 0 may have successfully decoded the sidelink message x₃, but may have failed to decode the sidelink message x₁. The UE 0 may have performed an XOR operation on the sidelink message x₃ and the sidelink message x₀ (e.g., transmitted by the UE 0) to obtain a network coded sidelink message corresponding to x₀Γx₃, and may have stored the network coded sidelink message at the UE 0. The UE 0 may receive the first network coded combined message corresponding to x₀Γx₁Γx₃. The UE 0 may perform an XOR operation on the network coded sidelink message and the first network coded combined message to extract data corresponding to the sidelink message x₁.

Applying network coding to generate combined messages for retransmission of sidelink messages as described in the present disclosure may reduce signaling overhead, resource consumption, and latency. In the example of FIG. 5, when five sidelink messages are associated with requested retransmissions, the transmitting device may transmit two network coded combined messages, where other retransmission schemes may use at least five retransmissions (e.g., one retransmission per sidelink message). As such, the transmitting device and the UEs may use the sidelink channels less frequently, avoiding channel congestion and link degradation. Additionally, fewer retransmissions may reduce processing power and power consumption, improve spectral efficiency of the system, and improve reliability.

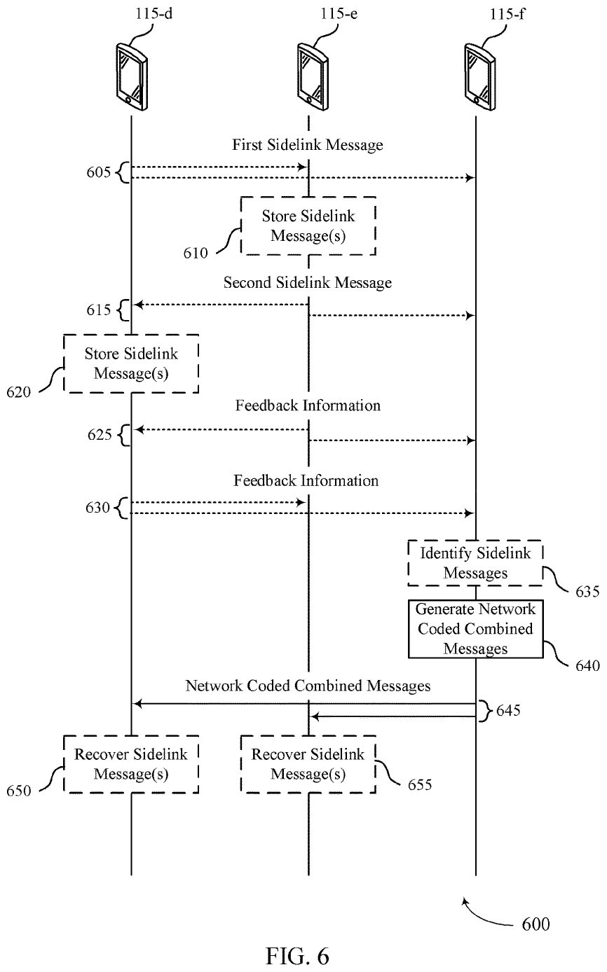

FIG. 6 illustrates an example of a process flow 600 that supports techniques for network coding based on device storage in accordance with various aspects of the present disclosure. In some examples, the process flow 600 may implement or be implemented by aspects of a wireless communications system 100 and 200 as described with reference to FIGS. 1 and 2. For example, the process flow 600 may be implemented by a UE 115-d, a UE 115-e, and a UE 115-f to support generating network coded combined messages for sidelink retransmissions. In the example of FIG. 6, the UE 115-f may be an example of a reliable UE, such as an RSU, a relay UE, or the like, as described herein.

The UE 115-d, the UE 115-e, and the UE 115-f may be examples of UEs 115 as described with reference to FIGS. 1 through 3. The UE 115-d, the UE 115-e, and the UE 115-f may be included in a group of UEs 115 that may communicate with one another via sidelink channels (e.g., PSSCH, PSCCH, or the like). For example, the UEs 115 may transmit and receive groupcast transmissions. Additionally, each of the UEs 115 in the process flow 600 may be associated with a respective storage capability for storing one or more sidelink messages. The storage capability may correspond to a quantity of sidelink messages, a quantity of network coded sidelink messages, or a combination thereof, that a UE 115 is able to store. A UE 115 may, for example, be capable of storing multiple sidelink messages (e.g., multiple decoded sidelink messages, where each decoded sidelink message is stored at the UE 115 in its entirety) that are received at the UE 115 or are generated by the UE 115 for transmission. Alternatively, a UE 115 may have a limited storage capacity, such that the UE 115 is capable of storing a limited quantity of sidelink messages. In some examples of limited storage capacity, the UE 115 may not be capable of storing full decoded sidelink messages. Here, the UE 115 may combine sidelink messages (e.g., decoded sidelink messages received at the UE 115, unencoded sidelink messages generated at the UE 115 for transmission by the UE 115) using network coding, where the UE 115 is capable of storing a quantity of network coded sidelink messages.

In the following description of the process flow 600, the operations between the UE 115-d, the UE 115-e, and the UE 115-f may be communicated in a different order than the example order shown, or the operations performed by the UE 115-d, the UE 115-e, and the UE 115-f may be performed in different orders or at different times. Some operations may also be omitted from the process flow 600, and other operations may be added to the process flow 600. Further, although some operations or signaling may be shown to occur at different times for discussion purposes, these operations may actually occur at the same time.

At 605, the UE 115-d may transmit (e.g., groupcast), and the UE 115-e and the UE 115-f may receive, a first sidelink message via one or more sidelink channels. The UE 115-f may successfully decode the first sidelink message. In some cases, the UE 115-e may successfully decode the first sidelink message, while in other cases, the UE 115-e may fail to successfully decode the first sidelink message.

At 610, the UE 115-e may optionally store at least a portion of the first sidelink message, e.g., based on a storage capability of the UE 115-e. In some examples, the UE 115-e may be capable of storing all decoded data associated with the first sidelink message, while in other examples, the UE 115-e may have a relatively limited storage capability (e.g., a limited storage capacity) and may store a portion of data associated with the first sidelink message. In some cases, such as when the UE 115-e has a limited storage capability, the UE 115-e may combine (e.g., using network coding, such as XOR logic) data associated with the first sidelink message with data associated with one or more other received sidelink messages, or with data associated with a sidelink message to be transmitted by the UE 115-e (e.g., at 615), to obtain a network coded sidelink message. The UE 115-e may store the network coded sidelink message at the UE 115-e. In some examples, based on the storage capability, the UE 115-e may store one or more network coded combined messages and one or more decoded sidelink messages.

Additionally, in some examples, the UE 115-e may store one or more sidelink messages transmitted (or to be transmitted) by the UE 115-e. For example, the UE 115-e may store all or a portion of data associated with a second sidelink message to be transmitted by the UE 115-e at 615. If the UE 115-e has a relatively large (e.g., unlimited) storage capability (e.g., storage capacity), the UE 115-e may store all of the data associated with the second sidelink message. Alternatively, if the UE 115-e has a relatively limited storage capability (e.g., storage capacity), the UE 115-e may store a portion of the data associated with the second sidelink message. For instance, the UE 115-e may use network coding to combine data associated with the second sidelink message with data associated with the first sidelink message and obtain a network coded sidelink message. The UE 115-e may store the network coded sidelink message at the UE 115-e.

At 615, the UE 115-e may transmit (e.g., groupcast), and the UE 115-d and the UE 115-f may receive, the second sidelink message via the one or more sidelink channels. The UE 115-f may successfully decode the second sidelink message. In some cases, the UE 115-d may successfully decode the first sidelink message, while in other cases, the UE 115-d may fail to successfully decode the first sidelink message.

At 620, the UE 115-d may optionally store at least a portion of the second sidelink message, e.g., based on a storage capability of the UE 115-d. In some examples, the UE 115-d may be capable of storing all decoded data associated with the second sidelink message, while in other examples, the UE 115-d may have a relatively limited storage capability (e.g., a limited storage capacity) and may store a portion of data associated with the second sidelink message. In some cases, such as when the UE 115-d has a limited storage capability, the UE 115-d may combine (e.g., using network coding, such as XOR logic) data associated with the second sidelink message with data associated with one or more other received sidelink messages or with data associated with a sidelink message transmitted by the UE 115-d (e.g., at 605) to obtain a network coded sidelink message. The UE 115-d may store the network coded sidelink message at the UE 115-d. In some examples, based on the storage capability, the UE 115-d may store one or more network coded combined messages and one or more decoded sidelink messages.

Additionally, in some examples, the UE 115-d may store one or more sidelink messages transmitted (or to be transmitted) by the UE 115-d. For example, the UE 115-d may store all or a portion of data associated with the first sidelink message transmitted by the UE 115-d at 605. If the UE 115-d has a relatively large (e.g., unlimited) storage capability (e.g., storage capacity), the UE 115-d may store all of the data associated with the first sidelink message. Alternatively, if the UE 115-d has a relatively limited storage capability (e.g., storage capacity), the UE 115-d may store a portion of the data associated with the first sidelink message. For instance, the UE 115-d may use network coding to combine data associated with the second sidelink message with data associated with the first sidelink message and obtain a network coded sidelink message. The UE 115-d may store the network coded sidelink message at the UE 115-d.

At 625, the UE 115-e may transmit, and the UE 115-d and the UE 115-f may receive, feedback information associated with the first sidelink message received at 605. The feedback information may indicate an ACK or a NACK to indicate whether the UE 115-e successfully decoded the first sidelink message. For example, the feedback information may include a NACK requesting retransmission of the first sidelink message.

In some examples, the feedback information may indicate the storage capability of the UE 115-e for storing a set of decoded sidelink messages. For example, the feedback information may indicate a capability of the UE 115-e to store a quantity of decoded sidelink messages, a quantity of network coded sidelink messages, or a combination thereof, for the set of decoded sidelink messages. Additionally, or alternatively, the feedback information may indicate one or more decoded sidelink messages stored at the UE 115-e, one or more sidelink messages to be transmitted by the UE 115-e that are stored at the UE 115-e, one or more network coded sidelink messages stored at the UE 115-e, or a combination thereof.

For example, the feedback information may indicate that the UE 115-e has stored (e.g., at 610) all or a portion of the first sidelink message, all or a portion of the second sidelink message, or a combination thereof, at the UE 115-e. In some cases, the UE 115-e may implicitly indicate that the first sidelink message and/or the second sidelink message is stored at the UE 115-e by indicating the storage capability of the UE 115-e. Based on receiving the indication of the storage capability, the UE 115-f may infer or otherwise determine that the UE 115-e has stored all or a portion of the first sidelink message and all or a portion of the second sidelink message (e.g., because the UE 115-f is aware that the UE 115-e received the groupcasted first sidelink message at 605 and transmitted the second sidelink message at 615). Alternatively, the UE 115-e may explicitly indicate which sidelink messages are stored at the UE 115-e. For instance, the UE 115-e may indicate that the UE 115-e has stored the entirety of the decoded first sidelink message, or that the UE 115-e has stored a portion of the first sidelink message (e.g., as part of a network coded message). Additionally, in some cases, the UE 115-e may indicate, in the feedback information, both the storage capability of the UE 115-e and any sidelink messages (network coded or otherwise) stored at the UE 115-e.

In some examples, the UE 115-e may indicate, within the feedback information, a storage location of a stored sidelink message or network coded message. For instance, the UE 115-e may indicate that the first sidelink message is stored at a first storage location and that the second sidelink message is stored at a second storage location. The UE 115-f may infer a storage capability of the UE 115-e based on the indicated stored messages or storage locations.

At 630, the UE 115-d may transmit, and the UE 115-e and the UE 115-f may receive, feedback information associated with the second sidelink message received at 615. The feedback information may indicate an ACK or a NACK to indicate whether the UE 115-d successfully decoded the second sidelink message. For example, the feedback information may include a NACK requesting retransmission of the second sidelink message.

In some examples, the feedback information may indicate the storage capability of the UE 115-d for storing a set of decoded sidelink messages. For example, the feedback information may indicate a capability of the UE 115-d to store a quantity of decoded sidelink messages, a quantity of network coded sidelink messages, or a combination thereof, for the set of decoded sidelink messages. Additionally, or alternatively, the feedback information may indicate one or more decoded sidelink messages stored at the UE 115-d, one or more sidelink messages to be transmitted by the UE 115-d that are stored at the UE 115-d, one or more network coded sidelink messages stored at the UE 115-d, or a combination thereof.

For example, the feedback information may indicate that the UE 115-d has stored (e.g., at 620) all or a portion of the first sidelink message, all or a portion of the second sidelink message, or a combination thereof, at the UE 115-d. In some cases, the UE 115-d may implicitly indicate that the first sidelink message and/or the second sidelink message is stored at the UE 115-d by indicating the storage capability of the UE 115-d. Based on receiving the indication of the storage capability, the UE 115-f may infer or otherwise determine that the UE 115-d has stored all or a portion of the first sidelink message and all or a portion of the second sidelink message (e.g., because the UE 115-f is aware that the UE 115-d transmitted the first sidelink message at 605 and received the second sidelink message at 615). Alternatively, the UE 115-d may explicitly indicate which sidelink messages are stored at the UE 115-d. For instance, the UE 115-d may indicate that the UE 115-d has stored the entirety of the decoded second sidelink message, or that the UE 115-d has stored a portion of the second sidelink message (e.g., as part of a network coded message). Additionally, in some cases, the UE 115-d may indicate, in the feedback information, both the storage capability of the UE 115-d and any sidelink messages (network coded or otherwise) stored at the UE 115-d.

In some examples, the UE 115-d may indicate, in the feedback information, a storage location of a stored sidelink message or network coded message. For instance, the UE 115-d may indicate that the first sidelink message is stored at a first storage location and that the second sidelink message is stored at a second storage location. The UE 115-f may infer a storage capability of the UE 115-d based on the indicated stored messages or storage locations.

At 635, the UE 115-f may identify, from multiple sidelink messages received by the UE 115-f via the one or more sidelink channels and including the first sidelink message and the second sidelink message, a group of sidelink messages. The group of sidelink messages may be associated with feedback information (e.g., NACKs) requesting retransmission, e.g., for each sidelink message of the group of sidelink messages.

Additionally, or alternatively, the UE 115-f may identify one or more subsets of sidelink messages of the group of sidelink messages. For example, the UE 115-f may generate a subset of sidelink messages of the group of sidelink messages by performing an XOR operation on two or more sidelink messages of the group of sidelink messages.

At 640, the UE 115-f may generate one or more network coded combined messages corresponding to the one or more subsets of sidelink messages of the group of sidelink messages, e.g., based on the feedback information received at 625 and 630. The UE 115-f may generate the one or more network coded combined messages based on generating a first matrix including one or more first values, where the one or more first values indicate a requested retransmission for one or more sidelink messages of the group of sidelink messages. The one or more first values may be equal to 1. In the first matrix, each column may correspond to a respective sidelink message of the group of sidelink messages and each row may correspond to a respective UE (e.g., including the UE 115-d and the UE 115-e).

In some examples, for each of the UE 115-d and the UE 115-e, the UE 115-f may identify a first set of sidelink messages associated with negative feedback information (e.g., NACKs) from the respective UE 115 and a second set of sidelink messages associated with positive feedback information (e.g., ACKs) from the respective UE 115. For example, the UE 115-f may generate, for the UE 115-d, one or more rows in the first matrix, where each row of the one or more rows corresponds to a respective sidelink message of the first set of sidelink messages. In each row of the one or more rows, an index having a first value (e.g., 1) may indicate a requested retransmission for a corresponding sidelink message. The UE 115-f may identify the second set of sidelink messages using one or more second values (e.g., 0) in each row of the one or more rows.

In some examples, the UE 115-f may generate a second matrix based on the first matrix, for example, by reducing a rank of the first matrix. In some examples, the UE 115-f may generate the second matrix based on determining two or more first values of the first matrix that represent a sidelink message stored at a same storage location, and adjusting a value of the one or more first values to reduce the rank of the first matrix.

In some cases, the UE 115-f may generate a third matrix. In some examples, the UE 115-f may generate the third matrix based on a row basis of the second matrix (e.g., based on identifying a row basis of the second matrix) or a row basis of the first matrix (e.g., based on identifying a row basis of the first matrix). The third matrix may correspond to the one or more subsets of the sidelink messages. For instance, each row of the third matrix may correspond to a respective subset of the sidelink messages. The UE 115-f may generate the one or more network coded combined messages based on the third matrix, e.g., based on generating the third matrix.

In some examples, the UE 115-f may generate the one or more network coded combined messages based on identifying a reliability threshold. For example, the UE 115-f may determine whether a reliability threshold is satisfied, and may generate the one or more network coded combined messages if the reliability threshold is satisfied.

At 645, the UE 115-f may transmit, and the UE 115-d and the UE 115-e may receive, the one or more network coded combined messages corresponding to the one or more subsets of sidelink messages. In some cases, the UE 115-f may transmit, within the one or more network coded combined messages, an indication of the one or more subsets of sidelink messages. For example, the UE 115-f may indicate one or more rows of the third matrix corresponding to the one or more subsets of sidelink messages. The one or more network coded combined messages may be associated with an internet protocol layer, a PDCP layer, an RLC layer, a MAC layer, an RRC layer, or a combination thereof.

In some examples, the UE 115-f may transmit the one or more network coded combined messages based on transmitting SCI (e.g., SCI-1 or SCI-2) associated with the one or more network coded combined messages. For example, the UE 115-f may transmit, and the UE 115-d and the UE 115-e may receive, SCI scheduling the one or more network coded combined messages. The UE 115-f may include, in the SCI, an indication that the one or more network coded combined messages are network coded combined messages. That is, in general, SCI scheduling a sidelink message may include an indication of whether the scheduled sidelink message is a network coded combined message.

Additionally, or alternatively, the UE 115-f may include a row vector of the third matrix in the SCI, where the row vector corresponds to the sidelink messages included in the one or more network coded combined messages being transmitted at 645. For example, the UE 115-f may indicate the row vector in an SCI-2 message. In some cases, the UE 115-f may indicate the row vector in an SCI-3 message. The SCI-3 message may, in some cases, be piggybacked on a PSSCH, such as a PSSCH associated with the one or more network coded combined messages.

At 650, the UE 115-d may recover or extract one or more sidelink messages for which the UE 115-d requested retransmission based on the one or more network coded combined messages and one or more sidelink messages (e.g., decoded sidelink messages, network coded sidelink messages) stored at the UE 115-d. For example, if the UE 115-d transmitted, at 630, a NACK requesting retransmission of the second sidelink message, the UE 115-d may utilize HARQ recombination techniques to obtain data associated with the second sidelink message. For example, the UE 115-d may perform an XOR operation on the one or more network coded combined messages, the first sidelink message, and one or more decoded sidelink messages to obtain the second sidelink message. Additionally, or alternatively, the UE 115-d may perform an XOR operation on the one or more network coded combined messages and one or more network coded sidelink messages to obtain the second sidelink message.

At 655, the UE 115-e may recover or extract one or more sidelink messages for which the UE 115-e requested retransmission based on the one or more network coded combined messages and one or more sidelink messages (e.g., decoded sidelink messages, network coded sidelink messages) stored at the UE 115-e. For example, if the UE 115-e transmitted, at 625, a NACK requesting retransmission of the first sidelink message, the UE 115-e may utilize HARQ recombination techniques to obtain data associated with the first sidelink message. For example, the UE 115-e may perform an XOR operation on the one or more network coded combined messages, the first sidelink message, and one or more decoded sidelink messages to obtain the first sidelink message. Additionally, or alternatively, the UE 115-e may perform an XOR operation on the one or more network coded combined messages and one or more network coded sidelink messages to obtain the first sidelink message.

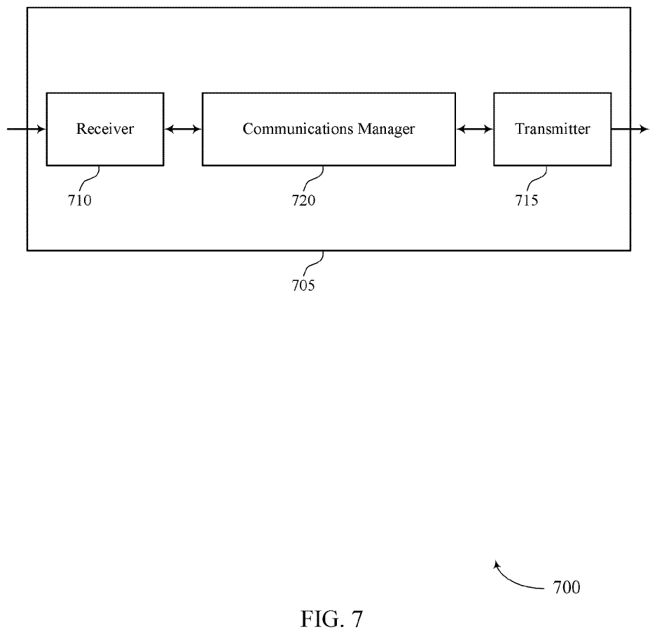

FIG. 7 shows a block diagram 700 of a device 705 that supports techniques for network coding based on device storage in accordance with various aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for network coding based on device storage). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for network coding based on device storage). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for network coding based on device storage as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a relay node in accordance with examples as disclosed herein. For example, the communications manager 720 may be configured as or otherwise support a means for receiving a set of multiple sidelink messages via one or more sidelink channels, the set of multiple sidelink messages including a group of sidelink messages associated with feedback information requesting retransmission for each sidelink message of the group of sidelink messages. The communications manager 720 may be configured as or otherwise support a means for generating one or more network coded combined messages corresponding to one or more subsets of sidelink messages of the group of sidelink messages based on the feedback information. The communications manager 720 may be configured as or otherwise support a means for transmitting, via the one or more sidelink channels, the one or more network coded combined messages and an indication of the one or more subsets of sidelink messages of the group of sidelink messages.

Additionally, or alternatively, the communications manager 720 may support wireless communication at a UE in accordance with examples as disclosed herein. For example, the communications manager 720 may be configured as or otherwise support a means for transmitting a sidelink message to one or more UEs of a set of multiple UEs. The communications manager 720 may be configured as or otherwise support a means for receiving a set of sidelink messages from the set of multiple UEs via one or more sidelink channels. The communications manager 720 may be configured as or otherwise support a means for transmitting feedback information associated with the set of sidelink messages, the feedback information requesting retransmission for at least one sidelink message of the set of sidelink messages. The communications manager 720 may be configured as or otherwise support a means for receiving one or more network coded combined messages corresponding to one or more subsets of sidelink messages of the set of sidelink messages including the at least one sidelink message based on the feedback information, the one or more network coded combined messages including an indication of the one or more subsets of sidelink messages.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced groupcast retransmissions via network coding, which may improve retransmission efficiency and reduce retransmission times. Additionally, reducing a quantity of groupcast retransmissions for a group of UEs may reduce resource usage, signaling overhead, and communication link congestion, thereby reducing processing and power consumption at the device 705 and for the group of UEs.

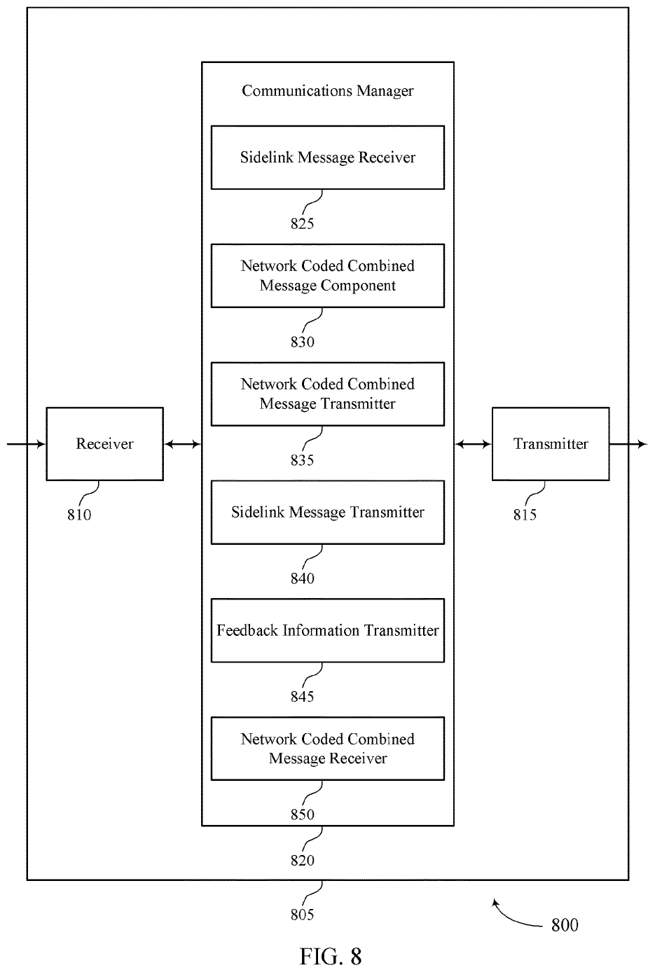

FIG. 8 shows a block diagram 800 of a device 805 that supports techniques for network coding based on device storage in accordance with various aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for network coding based on device storage). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for network coding based on device storage). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for network coding based on device storage as described herein. For example, the communications manager 820 may include a sidelink message receiver 825, a network coded combined message component 830, a network coded combined message transmitter 835, a sidelink message transmitter 840, a feedback information transmitter 845, a network coded combined message receiver 850, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a relay node in accordance with examples as disclosed herein. The sidelink message receiver 825 may be configured as or otherwise support a means for receiving a set of multiple sidelink messages via one or more sidelink channels, the set of multiple sidelink messages including a group of sidelink messages associated with feedback information requesting retransmission for each sidelink message of the group of sidelink messages. The network coded combined message component 830 may be configured as or otherwise support a means for generating one or more network coded combined messages corresponding to one or more subsets of sidelink messages of the group of sidelink messages based on the feedback information. The network coded combined message transmitter 835 may be configured as or otherwise support a means for transmitting, via the one or more sidelink channels, the one or more network coded combined messages and an indication of the one or more subsets of sidelink messages of the group of sidelink messages.

Additionally, or alternatively, the communications manager 820 may support wireless communication at a UE in accordance with examples as disclosed herein. The sidelink message transmitter 840 may be configured as or otherwise support a means for transmitting a sidelink message to one or more UEs of a set of multiple UEs. The sidelink message receiver 825 may be configured as or otherwise support a means for receiving a set of sidelink messages from the set of multiple UEs via one or more sidelink channels. The feedback information transmitter 845 may be configured as or otherwise support a means for transmitting feedback information associated with the set of sidelink messages, the feedback information requesting retransmission for at least one sidelink message of the set of sidelink messages. The network coded combined message receiver 850 may be configured as or otherwise support a means for receiving one or more network coded combined messages corresponding to one or more subsets of sidelink messages of the set of sidelink messages including the at least one sidelink message based on the feedback information, the one or more network coded combined messages including an indication of the one or more subsets of sidelink messages.

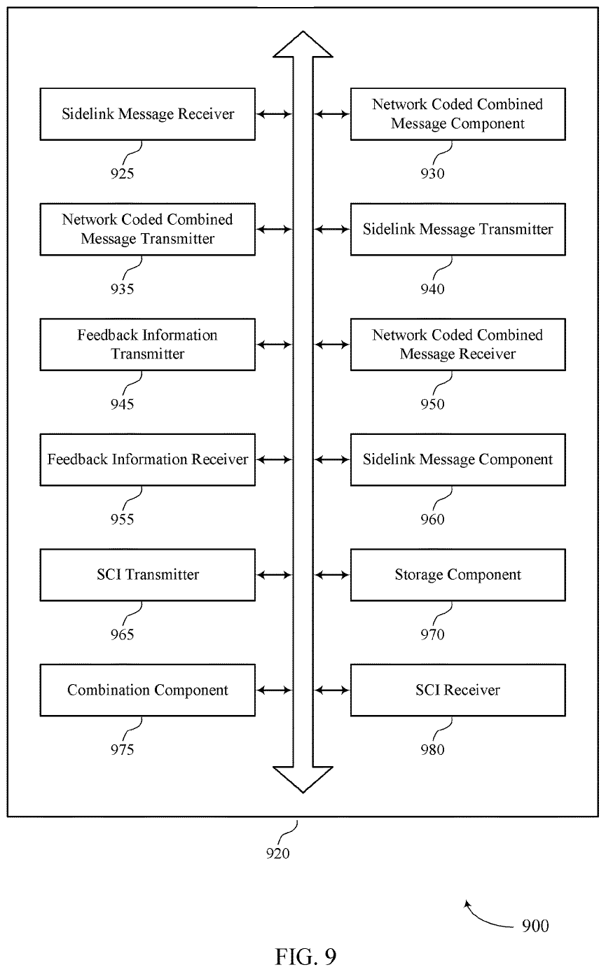

FIG. 9 shows a block diagram 900 of a communications manager 920 that supports techniques for network coding based on device storage in accordance with various aspects of the present disclosure. The communications manager 920 may be an example of aspects of a communications manager 720, a communications manager 820, or both, as described herein. The communications manager 920, or various components thereof, may be an example of means for performing various aspects of techniques for network coding based on device storage as described herein. For example, the communications manager 920 may include a sidelink message receiver 925, a network coded combined message component 930, a network coded combined message transmitter 935, a sidelink message transmitter 940, a feedback information transmitter 945, a network coded combined message receiver 950, a feedback information receiver 955, a sidelink message component 960, an SCI transmitter 965, a storage component 970, a combination component 975, an SCI receiver 980, or any combination thereof. Each of these components may communicate, directly or indirectly, with one another (e.g., via one or more buses).

The communications manager 920 may support wireless communication at a relay node in accordance with examples as disclosed herein. The sidelink message receiver 925 may be configured as or otherwise support a means for receiving a set of multiple sidelink messages via one or more sidelink channels, the set of multiple sidelink messages including a group of sidelink messages associated with feedback information requesting retransmission for each sidelink message of the group of sidelink messages. The network coded combined message component 930 may be configured as or otherwise support a means for generating one or more network coded combined messages corresponding to one or more subsets of sidelink messages of the group of sidelink messages based on the feedback information. The network coded combined message transmitter 935 may be configured as or otherwise support a means for transmitting, via the one or more sidelink channels, the one or more network coded combined messages and an indication of the one or more subsets of sidelink messages of the group of sidelink messages.

In some examples, the feedback information receiver 955 may be configured as or otherwise support a means for receiving the feedback information from a set of multiple UEs based on receiving the set of multiple sidelink messages, where generating the one or more network coded combined messages is based on receiving the feedback information. In some examples, the feedback information indicates a NACK, an ACK, or a combination thereof, for one or more sidelink messages of the group of sidelink messages.

In some examples, the feedback information indicates, for each UE of the set of multiple UEs, a storage capability for storing a set of decoded sidelink messages. In some examples, the storage capability indicates a capability to store a quantity of decoded sidelink messages, a quantity of sidelink messages for which the UE has performed an exclusive or operation, or any combination thereof, for the set of decoded sidelink messages. In some examples, the feedback information indicates, for each UE of the set of multiple UEs, one or more decoded sidelink messages stored at the UE, one or more network coded sidelink messages stored at the UE, or a combination thereof.

In some examples, to support generating the one or more network coded combined messages, the network coded combined message component 930 may be configured as or otherwise support a means for performing an exclusive or operation on two or more sidelink messages of the group of sidelink messages to generate a subset of sidelink messages of the one or more subsets of sidelink messages, where transmitting the one or more network coded combined messages is based on performing the exclusive or operation.

In some examples, the network coded combined message component 930 may be configured as or otherwise support a means for generating a first matrix including first values, the first values indicating a requested retransmission for one or more sidelink messages of the group of sidelink messages based on the feedback information, where generating the one or more network coded combined messages corresponding to the one or more subsets of sidelink messages is based on the first matrix. In some examples, each column of the first matrix corresponds to a respective sidelink message of the group of sidelink messages. In some examples, each row of the first matrix corresponds to a respective UE of a set of multiple UEs associated with the feedback information.

In some examples, the sidelink message component 960 may be configured as or otherwise support a means for identifying a first set of sidelink messages of the set of multiple sidelink messages for which a UE requests retransmission and a second set of sidelink messages of the set of multiple sidelink messages for which the UE fails to request retransmission. In some examples, the network coded combined message component 930 may be configured as or otherwise support a means for generating, for the UE, one or more rows in the first matrix, each row of the one or more rows corresponding to a respective sidelink message of the first set of sidelink messages. In some examples, the sidelink message component 960 may be configured as or otherwise support a means for identifying, in each row of the first matrix associated with the UE, the second set of sidelink messages using one or more second values.

In some examples, the network coded combined message component 930 may be configured as or otherwise support a means for generating a second matrix based on determining two or more first values of the first matrix that represent a sidelink message stored at a same storage location. In some examples, the network coded combined message component 930 may be configured as or otherwise support a means for adjusting a value of one of the two or more first values to reduce a rank associated with the first matrix, where generating the second matrix is based on adjusting the value. In some examples, the network coded combined message component 930 may be configured as or otherwise support a means for generating a third matrix based on a row basis of the second matrix, where generating the one or more network coded combined messages corresponding to the one or more subsets of sidelink messages of the group of sidelink messages is based on generating the third matrix. In some examples, the indication of the one or more subsets of sidelink messages includes one or more rows of the third matrix.

In some examples, the network coded combined message component 930 may be configured as or otherwise support a means for generating a third matrix based on a row basis of the first matrix, where generating the one or more network coded combined messages corresponding to the one or more subsets of sidelink messages of the group of sidelink messages is based on generating the third matrix. In some examples, the indication of the one or more subsets of sidelink messages includes one or more rows of the third matrix.

In some examples, the sidelink message component 960 may be configured as or otherwise support a means for identifying a reliability threshold for one or more sidelink messages of the set of multiple sidelink messages, where transmitting the one or more network coded combined messages is based on the reliability threshold. In some examples, the one or more network coded combined messages are associated with an internet protocol layer, a packet data convergence protocol layer, a radio link control layer, a medium access control layer, or any combination thereof.

In some examples, the relay node includes a sidelink UE.

In some examples, the SCI transmitter 965 may be configured as or otherwise support a means for transmitting SCI indicating whether one or more sidelink messages scheduled by the SCI are network coded combined messages.

Additionally, or alternatively, the communications manager 920 may support wireless communication at a UE in accordance with examples as disclosed herein. The sidelink message transmitter 940 may be configured as or otherwise support a means for transmitting a sidelink message to one or more UEs of a set of multiple UEs. In some examples, the sidelink message receiver 925 may be configured as or otherwise support a means for receiving a set of sidelink messages from the set of multiple UEs via one or more sidelink channels. The feedback information transmitter 945 may be configured as or otherwise support a means for transmitting feedback information associated with the set of sidelink messages, the feedback information requesting retransmission for at least one sidelink message of the set of sidelink messages. The network coded combined message receiver 950 may be configured as or otherwise support a means for receiving one or more network coded combined messages corresponding to one or more subsets of sidelink messages of the set of sidelink messages including the at least one sidelink message based on the feedback information, the one or more network coded combined messages including an indication of the one or more subsets of sidelink messages.

In some examples, the feedback information indicates a NACK, an ACK, or a combination thereof, for each sidelink message of the set of sidelink messages. In some examples, the feedback information indicates a storage capability of the UE for storing a set of decoded sidelink messages. In some examples, the storage capability indicates a capability of the UE to store a quantity of decoded sidelink messages, a quantity of network coded sidelink messages, or any combination thereof, for the set of sidelink messages. In some examples, the storage capability indicates one or more decoded sidelink messages stored at the UE, one or more network coded sidelink messages stored at the UE, or a combination thereof.

In some examples, the storage component 970 may be configured as or otherwise support a means for storing, at the UE, one or more decoded sidelink messages of the set of sidelink messages. In some examples, the combination component 975 may be configured as or otherwise support a means for performing an exclusive or operation on the one or more decoded sidelink messages, the sidelink message, and the one or more network coded combined messages to obtain the at least one sidelink message. In some examples, the feedback information indicates a storage capability of the UE for storing the one or more decoded sidelink messages. In some examples, the feedback information indicates the one or more decoded sidelink messages stored at the UE.

In some examples, the combination component 975 may be configured as or otherwise support a means for performing an exclusive or operation on the sidelink message and one or more decoded sidelink messages of the set of sidelink messages to obtain a network coded sidelink message. In some examples, the storage component 970 may be configured as or otherwise support a means for storing, at the UE, the network coded sidelink message. In some examples, the combination component 975 may be configured as or otherwise support a means for performing an exclusive or operation on the network coded sidelink message and the one or more network coded combined messages to obtain the at least one sidelink message.

In some examples, the feedback information indicates a storage capability of the UE for storing the network coded sidelink message. In some examples, the feedback information indicates the one or more decoded sidelink messages associated with the network coded sidelink message stored at the UE. In some examples, the one or more network coded combined messages are associated with an internet protocol layer, a packet data convergence protocol layer, a radio link control layer, a medium access control layer, or any combination thereof.

In some examples, the one or more network coded combined messages are received from a relay node.

In some examples, the SCI receiver 980 may be configured as or otherwise support a means for receiving SCI indicating whether one or more sidelink messages scheduled by the SCI are network coded combined messages.

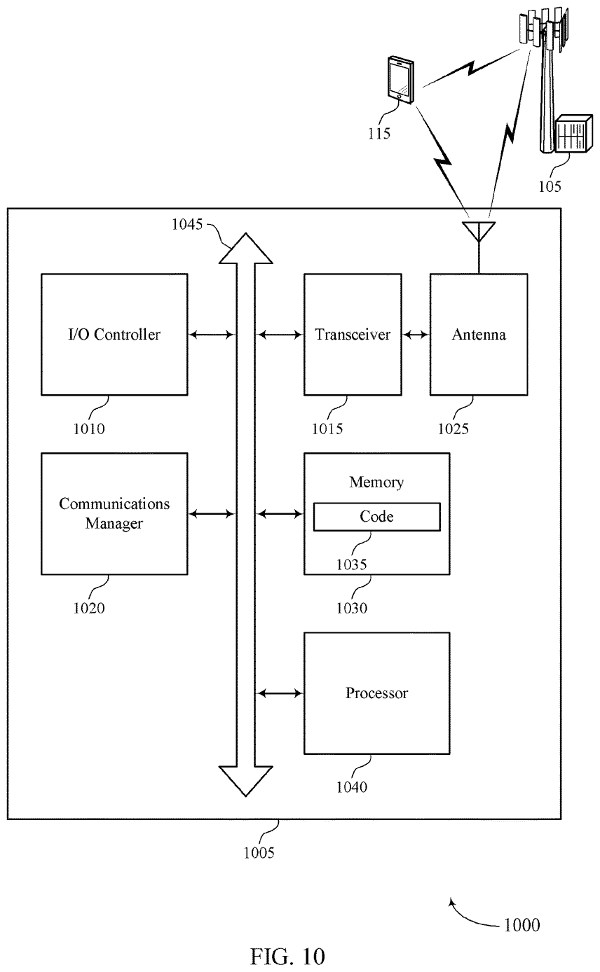

FIG. 10 shows a diagram of a system 1000 including a device 1005 that supports techniques for network coding based on device storage in accordance with various aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for network coding based on device storage). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a relay node in accordance with examples as disclosed herein. For example, the communications manager 1020 may be configured as or otherwise support a means for receiving a set of multiple sidelink messages via one or more sidelink channels, the set of multiple sidelink messages including a group of sidelink messages associated with feedback information requesting retransmission for each sidelink message of the group of sidelink messages. The communications manager 1020 may be configured as or otherwise support a means for generating one or more network coded combined messages corresponding to one or more subsets of sidelink messages of the group of sidelink messages based on the feedback information. The communications manager 1020 may be configured as or otherwise support a means for transmitting, via the one or more sidelink channels, the one or more network coded combined messages and an indication of the one or more subsets of sidelink messages of the group of sidelink messages.

Additionally, or alternatively, the communications manager 1020 may support wireless communication at a UE in accordance with examples as disclosed herein. For example, the communications manager 1020 may be configured as or otherwise support a means for transmitting a sidelink message to one or more UEs of a set of multiple UEs. The communications manager 1020 may be configured as or otherwise support a means for receiving a set of sidelink messages from the set of multiple UEs via one or more sidelink channels. The communications manager 1020 may be configured as or otherwise support a means for transmitting feedback information associated with the set of sidelink messages, the feedback information requesting retransmission for at least one sidelink message of the set of sidelink messages. The communications manager 1020 may be configured as or otherwise support a means for receiving one or more network coded combined messages corresponding to one or more subsets of sidelink messages of the set of sidelink messages including the at least one sidelink message based on the feedback information, the one or more network coded combined messages including an indication of the one or more subsets of sidelink messages.

By including or configuring the communications manager 1020 in accordance with examples as described herein, the device 1005 may support techniques for reduced groupcast retransmissions via network coding, which may improve retransmission efficiency and reduce retransmission times. Additionally, reducing a quantity of groupcast retransmissions for a group of UEs may improve efficiency in utilization of communication resources, improve coordination between devices, and reduce latency, thereby reducing processing and power consumption at the device 1005 and for the group of UEs.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for network coding based on device storage as described herein, or the processor 1040 and the memory 1030 may be otherwise configured to perform or support such operations.

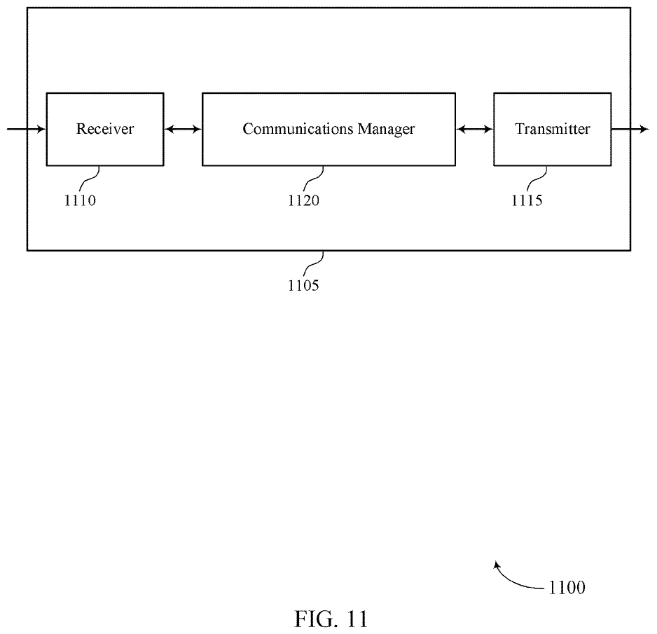

FIG. 11 shows a block diagram 1100 of a device 1105 that supports techniques for network coding based on device storage in accordance with various aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for network coding based on device storage as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a relay node in accordance with examples as disclosed herein. For example, the communications manager 1120 may be configured as or otherwise support a means for receiving a set of multiple sidelink messages via one or more sidelink channels, the set of multiple sidelink messages including a group of sidelink messages associated with feedback information requesting retransmission for each sidelink message of the group of sidelink messages. The communications manager 1120 may be configured as or otherwise support a means for generating one or more network coded combined messages corresponding to one or more subsets of sidelink messages of the group of sidelink messages based on the feedback information. The communications manager 1120 may be configured as or otherwise support a means for transmitting, via the one or more sidelink channels, the one or more network coded combined messages and an indication of the one or more subsets of sidelink messages of the group of sidelink messages.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced groupcast retransmissions via network coding, which may improve retransmission efficiency and reduce retransmission times. Additionally, reducing a quantity of groupcast retransmissions for a group of UEs may reduce resource usage, signaling overhead, and communication link congestion, thereby reducing processing and power consumption at the device 1105 and for the group of UEs.

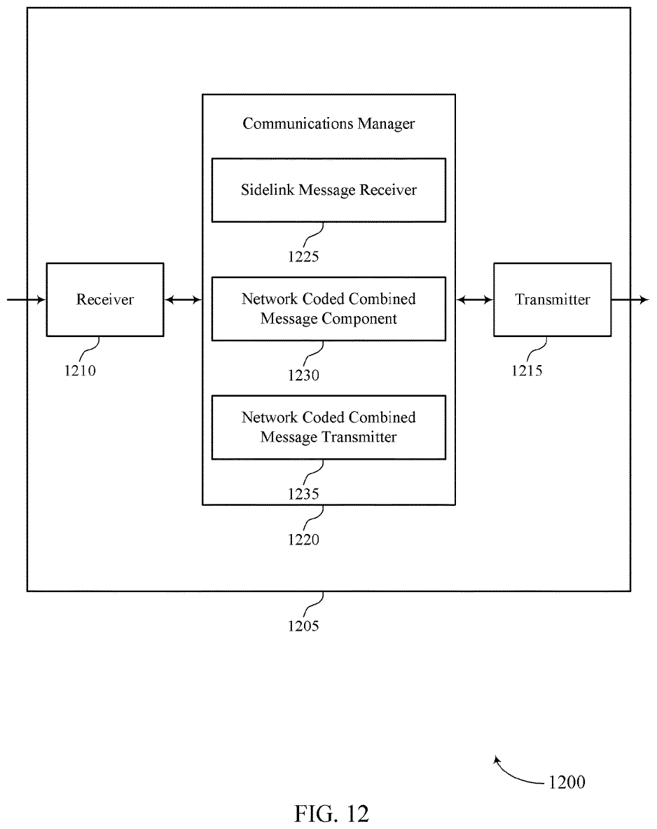

FIG. 12 shows a block diagram 1200 of a device 1205 that supports techniques for network coding based on device storage in accordance with various aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for network coding based on device storage as described herein. For example, the communications manager 1220 may include a sidelink message receiver 1225, a network coded combined message component 1230, a network coded combined message transmitter 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a relay node in accordance with examples as disclosed herein. The sidelink message receiver 1225 may be configured as or otherwise support a means for receiving a set of multiple sidelink messages via one or more sidelink channels, the set of multiple sidelink messages including a group of sidelink messages associated with feedback information requesting retransmission for each sidelink message of the group of sidelink messages. The network coded combined message component 1230 may be configured as or otherwise support a means for generating one or more network coded combined messages corresponding to one or more subsets of sidelink messages of the group of sidelink messages based on the feedback information. The network coded combined message transmitter 1235 may be configured as or otherwise support a means for transmitting, via the one or more sidelink channels, the one or more network coded combined messages and an indication of the one or more subsets of sidelink messages of the group of sidelink messages.

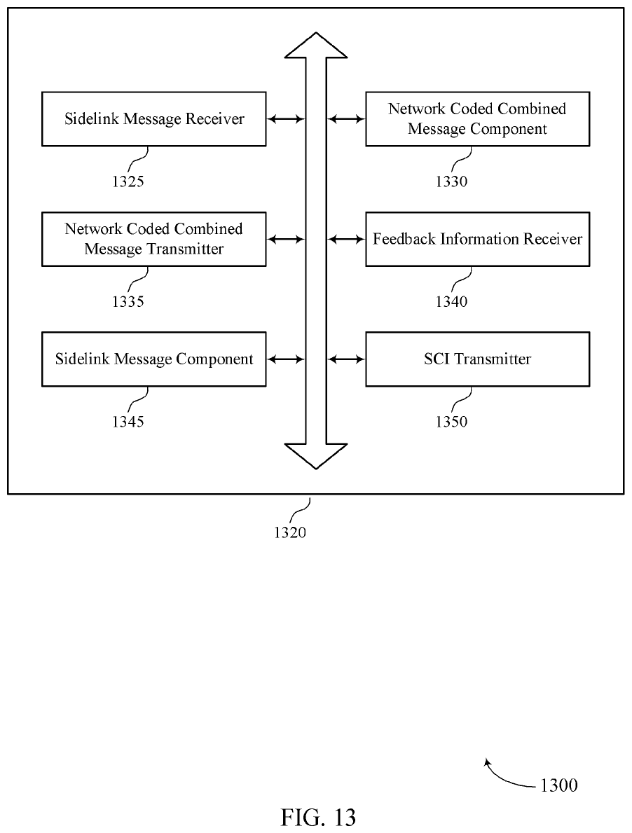

FIG. 13 shows a block diagram 1300 of a communications manager 1320 that supports techniques for network coding based on device storage in accordance with various aspects of the present disclosure. The communications manager 1320 may be an example of aspects of a communications manager 1120, a communications manager 1220, or both, as described herein. The communications manager 1320, or various components thereof, may be an example of means for performing various aspects of techniques for network coding based on device storage as described herein. For example, the communications manager 1320 may include a sidelink message receiver 1325, a network coded combined message component 1330, a network coded combined message transmitter 1335, a feedback information receiver 1340, a sidelink message component 1345, an SCI transmitter 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a relay node in accordance with examples as disclosed herein. The sidelink message receiver 1325 may be configured as or otherwise support a means for receiving a set of multiple sidelink messages via one or more sidelink channels, the set of multiple sidelink messages including a group of sidelink messages associated with feedback information requesting retransmission for each sidelink message of the group of sidelink messages. The network coded combined message component 1330 may be configured as or otherwise support a means for generating one or more network coded combined messages corresponding to one or more subsets of sidelink messages of the group of sidelink messages based on the feedback information. The network coded combined message transmitter 1335 may be configured as or otherwise support a means for transmitting, via the one or more sidelink channels, the one or more network coded combined messages and an indication of the one or more subsets of sidelink messages of the group of sidelink messages.

In some examples, the feedback information receiver 1340 may be configured as or otherwise support a means for receiving the feedback information from a set of multiple user equipments (UEs) based on receiving the set of multiple sidelink messages, where generating the one or more network coded combined messages is based on receiving the feedback information. In some examples, the feedback information indicates a NACK, an ACK, or a combination thereof, for one or more sidelink messages of the group of sidelink messages. In some examples, the feedback information indicates, for each UE of the set of multiple UEs, a storage capability for storing a set of decoded sidelink messages. In some examples, the storage capability indicates a capability to store a quantity of decoded sidelink messages, a quantity of sidelink messages for which the UE has performed an exclusive or operation, or any combination thereof, for the set of decoded sidelink messages. In some examples, the feedback information indicates, for each UE of the set of multiple UEs, one or more decoded sidelink messages stored at the UE, one or more network coded sidelink messages stored at the UE, or a combination thereof.

In some examples, to support generating the one or more network coded combined messages, the network coded combined message component 1330 may be configured as or otherwise support a means for performing an exclusive or operation on two or more sidelink messages of the group of sidelink messages to generate a subset of sidelink messages of the one or more subsets of sidelink messages, where transmitting the one or more network coded combined messages is based on performing the exclusive or operation.

In some examples, the network coded combined message component 1330 may be configured as or otherwise support a means for generating a first matrix including first values, the first values indicating a requested retransmission for one or more sidelink messages of the group of sidelink messages based on the feedback information, where generating the one or more network coded combined messages corresponding to the one or more subsets of sidelink messages is based on the first matrix. In some examples, each column of the first matrix corresponds to a respective sidelink message of the group of sidelink messages. In some examples, each row of the first matrix corresponds to a respective UE of a set of multiple UEs associated with the feedback information.

In some examples, the sidelink message component 1345 may be configured as or otherwise support a means for identifying a first set of sidelink messages of the set of multiple sidelink messages for which a UE requests retransmission and a second set of sidelink messages of the set of multiple sidelink messages for which the UE fails to request retransmission. In some examples, the network coded combined message component 1330 may be configured as or otherwise support a means for generating, for the UE, one or more rows in the first matrix, each row of the one or more rows corresponding to a respective sidelink message of the first set of sidelink messages. In some examples, the sidelink message component 1345 may be configured as or otherwise support a means for identifying, in each row of the first matrix associated with the UE, the second set of sidelink messages using one or more second values.

In some examples, the network coded combined message component 1330 may be configured as or otherwise support a means for generating a second matrix based on determining two or more first values of the first matrix that represent a sidelink message stored at a same storage location. In some examples, the network coded combined message component 1330 may be configured as or otherwise support a means for adjusting a value of one of the two or more first values to reduce a rank associated with the first matrix, where generating the second matrix is based on adjusting the value.

In some examples, the network coded combined message component 1330 may be configured as or otherwise support a means for generating a third matrix based on a row basis of the second matrix, where generating the one or more network coded combined messages corresponding to the one or more subsets of sidelink messages of the group of sidelink messages is based on generating the third matrix. In some examples, the indication of the one or more subsets of sidelink messages includes one or more rows of the third matrix.

In some examples, the network coded combined message component 1330 may be configured as or otherwise support a means for generating a third matrix based on a row basis of the first matrix, where generating the one or more network coded combined messages corresponding to the one or more subsets of sidelink messages of the group of sidelink messages is based on generating the third matrix. In some examples, the indication of the one or more subsets of sidelink messages includes one or more rows of the third matrix.

In some examples, the sidelink message component 1345 may be configured as or otherwise support a means for identifying a reliability threshold for one or more sidelink messages of the set of multiple sidelink messages, where transmitting the one or more network coded combined messages is based on the reliability threshold.

In some examples, the one or more network coded combined messages are associated with an internet protocol layer, a packet data convergence protocol layer, a radio link control layer, a medium access control layer, or any combination thereof.

In some examples, the relay node includes a sidelink UE.

In some examples, the SCI transmitter 1350 may be configured as or otherwise support a means for transmitting SCI indicating whether one or more sidelink messages scheduled by the SCI are network coded combined messages.

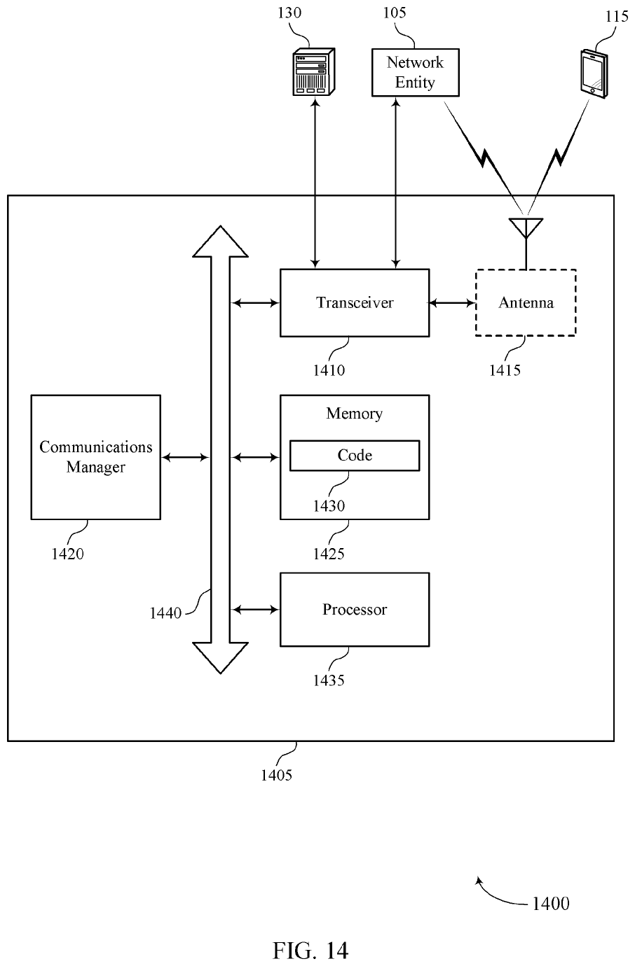

FIG. 14 shows a diagram of a system 1400 including a device 1405 that supports techniques for network coding based on device storage in accordance with various aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for network coding based on device storage). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1405 may transmit information output from the chip or modem. In some implementations, the second interface may refer to an interface between the processing system of the chip or modem and a receiver, such that the device 1405 may obtain information or signal inputs, and the information may be passed to the processing system. A person having ordinary skill in the art will readily recognize that the first interface also may obtain information or signal inputs, and the second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a relay node in accordance with examples as disclosed herein. For example, the communications manager 1420 may be configured as or otherwise support a means for receiving a set of multiple sidelink messages via one or more sidelink channels, the set of multiple sidelink messages including a group of sidelink messages associated with feedback information requesting retransmission for each sidelink message of the group of sidelink messages. The communications manager 1420 may be configured as or otherwise support a means for generating one or more network coded combined messages corresponding to one or more subsets of sidelink messages of the group of sidelink messages based on the feedback information. The communications manager 1420 may be configured as or otherwise support a means for transmitting, via the one or more sidelink channels, the one or more network coded combined messages and an indication of the one or more subsets of sidelink messages of the group of sidelink messages.

By including or configuring the communications manager 1420 in accordance with examples as described herein, the device 1405 may support techniques for reduced groupcast retransmissions via network coding, which may improve retransmission efficiency and reduce retransmission times. Additionally, reducing a quantity of groupcast retransmissions for a group of UEs may improve efficiency in utilization of communication resources, improve coordination between devices, and reduce latency, thereby reducing processing and power consumption at the device 1405 and for the group of UEs.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of techniques for network coding based on device storage as described herein, or the processor 1435 and the memory 1425 may be otherwise configured to perform or support such operations.

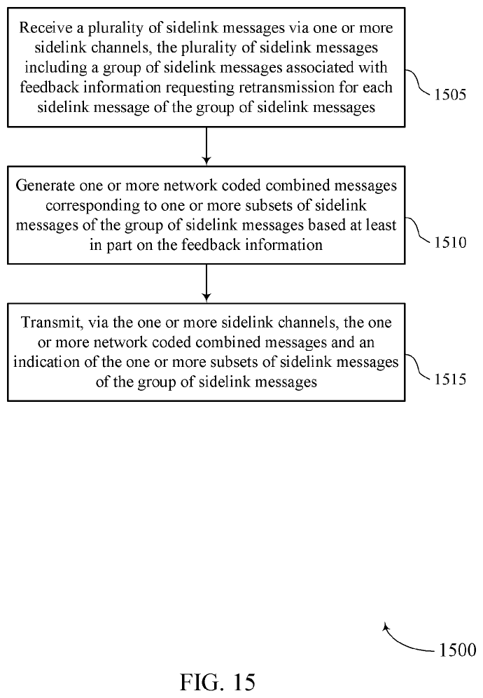

FIG. 15 shows a flowchart illustrating a method 1500 that supports techniques for network coding based on device storage in accordance with various aspects of the present disclosure. The operations of the method 1500 may be implemented by a UE or a network entity or its components as described herein. For example, the operations of the method 1500 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1505, the method may include receiving a set of multiple sidelink messages via one or more sidelink channels, the set of multiple sidelink messages including a group of sidelink messages associated with feedback information requesting retransmission for each sidelink message of the group of sidelink messages. The operations of 1505 may be performed in accordance with examples as disclosed herein. In some examples, aspects of the operations of 1505 may be performed by a sidelink message receiver 925 or a sidelink message receiver 1325 as described with reference to FIGS. 9 and 13.

At 1510, the method may include generating one or more network coded combined messages corresponding to one or more subsets of sidelink messages of the group of sidelink messages based on the feedback information. The operations of 1510 may be performed in accordance with examples as disclosed herein. In some examples, aspects of the operations of 1510 may be performed by a network coded combined message component 930 or a network coded combined message component 1330 as described with reference to FIGS. 9 and 13.

At 1515, the method may include transmitting, via the one or more sidelink channels, the one or more network coded combined messages and an indication of the one or more subsets of sidelink messages of the group of sidelink messages. The operations of 1515 may be performed in accordance with examples as disclosed herein. In some examples, aspects of the operations of 1515 may be performed by a network coded combined message transmitter 935 or a network coded combined message transmitter 1335 as described with reference to FIGS. 9 and 13.

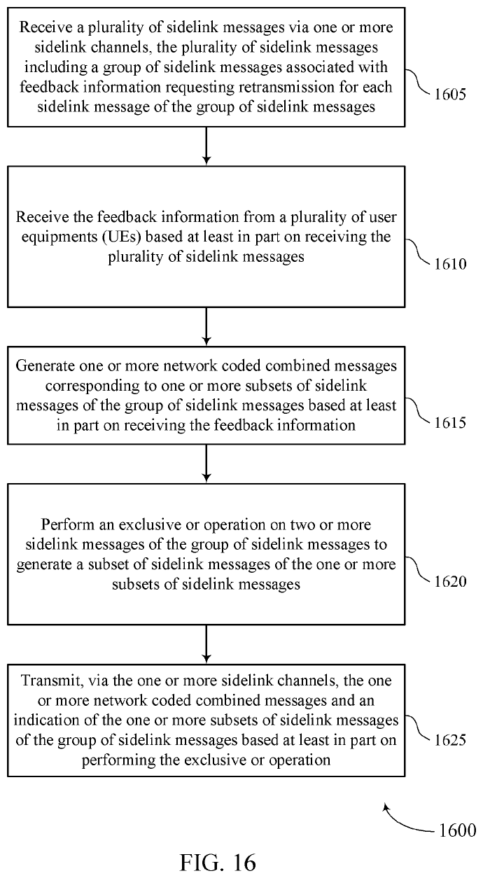

FIG. 16 shows a flowchart illustrating a method 1600 that supports techniques for network coding based on device storage in accordance with various aspects of the present disclosure. The operations of the method 1600 may be implemented by a UE or a network entity or its components as described herein. For example, the operations of the method 1600 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include receiving a set of multiple sidelink messages via one or more sidelink channels, the set of multiple sidelink messages including a group of sidelink messages associated with feedback information requesting retransmission for each sidelink message of the group of sidelink messages. The operations of 1605 may be performed in accordance with examples as disclosed herein. In some examples, aspects of the operations of 1605 may be performed by a sidelink message receiver 925 or a sidelink message receiver 1325 as described with reference to FIGS. 9 and 13.

At 1610, the method may include receiving the feedback information from a set of multiple UEs based on receiving the set of multiple sidelink messages. The operations of 1610 may be performed in accordance with examples as disclosed herein. In some examples, aspects of the operations of 1610 may be performed by a feedback information receiver 955 or a feedback information receiver 1340 as described with reference to FIGS. 9 and 13.

At 1615, the method may include generating one or more network coded combined messages corresponding to one or more subsets of sidelink messages of the group of sidelink messages based on receiving the feedback information. The operations of 1615 may be performed in accordance with examples as disclosed herein. In some examples, aspects of the operations of 1615 may be performed by a network coded combined message component 930 or a network coded combined message component 1330 as described with reference to FIGS. 9 and 13.

At 1620, the method may include performing an exclusive or operation on two or more sidelink messages of the group of sidelink messages to generate a subset of sidelink messages of the one or more subsets of sidelink messages. The operations of 1620 may be performed in accordance with examples as disclosed herein. In some examples, aspects of the operations of 1620 may be performed by a network coded combined message component 930 or a network coded combined message component 1330 as described with reference to FIGS. 9 and 13.

At 1625, the method may include transmitting, via the one or more sidelink channels, the one or more network coded combined messages and an indication of the one or more subsets of sidelink messages of the group of sidelink messages, where transmitting the one or more network coded combined messages is based on performing the exclusive or operation. The operations of 1625 may be performed in accordance with examples as disclosed herein. In some examples, aspects of the operations of 1625 may be performed by a network coded combined message transmitter 935 or a network coded combined message transmitter 1335 as described with reference to FIGS. 9 and 13.

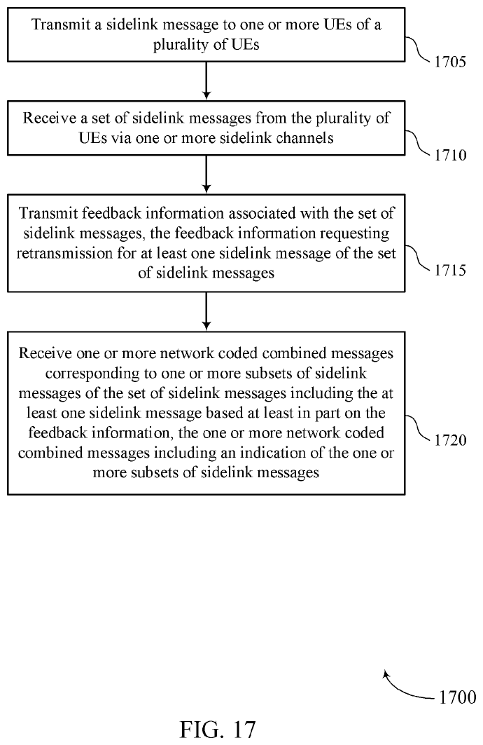

FIG. 17 shows a flowchart illustrating a method 1700 that supports techniques for network coding based on device storage in accordance with various aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting a sidelink message to one or more UEs of a set of multiple UEs. The operations of 1705 may be performed in accordance with examples as disclosed herein. In some examples, aspects of the operations of 1705 may be performed by a sidelink message transmitter 940 as described with reference to FIG. 9.

At 1710, the method may include receiving a set of sidelink messages from the set of multiple UEs via one or more sidelink channels. The operations of 1710 may be performed in accordance with examples as disclosed herein. In some examples, aspects of the operations of 1710 may be performed by a sidelink message receiver 925 as described with reference to FIG. 9.

At 1715, the method may include transmitting feedback information associated with the set of sidelink messages, the feedback information requesting retransmission for at least one sidelink message of the set of sidelink messages. The operations of 1715 may be performed in accordance with examples as disclosed herein. In some examples, aspects of the operations of 1715 may be performed by a feedback information transmitter 945 as described with reference to FIG. 9.

At 1720, the method may include receiving one or more network coded combined messages corresponding to one or more subsets of sidelink messages of the set of sidelink messages including the at least one sidelink message based on the feedback information, the one or more network coded combined messages including an indication of the one or more subsets of sidelink messages. The operations of 1720 may be performed in accordance with examples as disclosed herein. In some examples, aspects of the operations of 1720 may be performed by a network coded combined message receiver 950 as described with reference to FIG. 9.

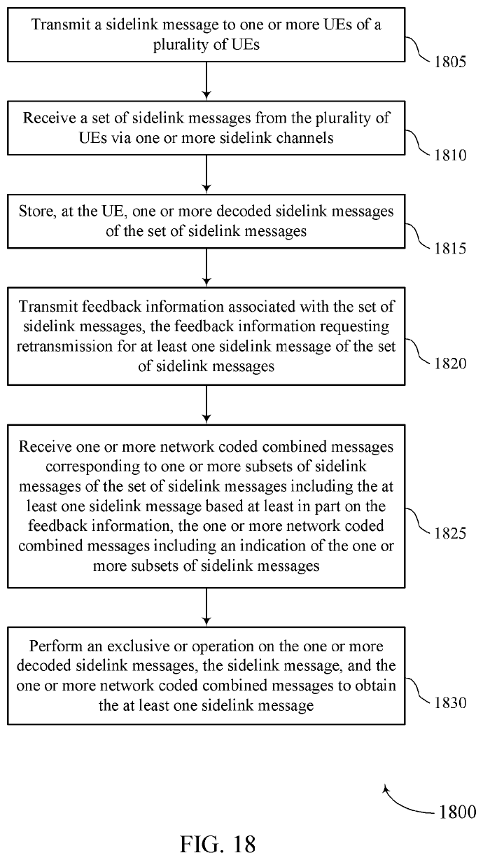

FIG. 18 shows a flowchart illustrating a method 1800 that supports techniques for network coding based on device storage in accordance with various aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include transmitting a sidelink message to one or more UEs of a set of multiple UEs. The operations of 1805 may be performed in accordance with examples as disclosed herein. In some examples, aspects of the operations of 1805 may be performed by a sidelink message transmitter 940 as described with reference to FIG. 9.

At 1810, the method may include receiving a set of sidelink messages from the set of multiple UEs via one or more sidelink channels. The operations of 1810 may be performed in accordance with examples as disclosed herein. In some examples, aspects of the operations of 1810 may be performed by a sidelink message receiver 925 as described with reference to FIG. 9.

At 1815, the method may include storing, at the UE, one or more decoded sidelink messages of the set of sidelink messages. The operations of 1815 may be performed in accordance with examples as disclosed herein. In some examples, aspects of the operations of 1815 may be performed by a storage component 970 as described with reference to FIG. 9.

At 1820, the method may include transmitting feedback information associated with the set of sidelink messages, the feedback information requesting retransmission for at least one sidelink message of the set of sidelink messages. The operations of 1820 may be performed in accordance with examples as disclosed herein. In some examples, aspects of the operations of 1820 may be performed by a feedback information transmitter 945 as described with reference to FIG. 9.

At 1825, the method may include receiving one or more network coded combined messages corresponding to one or more subsets of sidelink messages of the set of sidelink messages including the at least one sidelink message based on the feedback information, the one or more network coded combined messages including an indication of the one or more subsets of sidelink messages. The operations of 1825 may be performed in accordance with examples as disclosed herein. In some examples, aspects of the operations of 1825 may be performed by a network coded combined message receiver 950 as described with reference to FIG. 9.

At 1830, the method may include performing an exclusive or operation on the one or more decoded sidelink messages, the sidelink message, and the one or more network coded combined messages to obtain the at least one sidelink message. The operations of 1830 may be performed in accordance with examples as disclosed herein. In some examples, aspects of the operations of 1830 may be performed by a combination component 975 as described with reference to FIG. 9.

The following provides an overview of aspects of the present disclosure:

Aspect 1: A method for wireless communication at a relay node, comprising: receiving a plurality of sidelink messages via one or more sidelink channels, the plurality of sidelink messages including a group of sidelink messages associated with feedback information requesting retransmission for each sidelink message of the group of sidelink messages; generating one or more network coded combined messages corresponding to one or more subsets of sidelink messages of the group of sidelink messages based at least in part on the feedback information; and transmitting, via the one or more sidelink channels, the one or more network coded combined messages and an indication of the one or more subsets of sidelink messages of the group of sidelink messages.

Aspect 2: The method of aspect 1, further comprising: receiving the feedback information from a plurality of UEs based at least in part on receiving the plurality of sidelink messages, wherein generating the one or more network coded combined messages is based at least in part on receiving the feedback information.

Aspect 3: The method of aspect 2, wherein the feedback information indicates a NACK, an ACK, or a combination thereof, for one or more sidelink messages of the group of sidelink messages.

Aspect 4: The method of any of aspects 2 through 3, wherein the feedback information indicates, for each UE of the plurality of UEs, a storage capability for storing a set of decoded sidelink messages.

Aspect 5: The method of aspect 4, wherein the storage capability indicates a capability to store a quantity of decoded sidelink messages, a quantity of sidelink messages for which the UE has performed an exclusive or operation, or any combination thereof, for the set of decoded sidelink messages.

Aspect 6: The method of any of aspects 2 through 5, wherein the feedback information indicates, for each UE of the plurality of UEs, one or more decoded sidelink messages stored at the UE, one or more network coded sidelink messages stored at the UE, or a combination thereof.

Aspect 7: The method of any of aspects 1 through 6, wherein generating the one or more network coded combined messages further comprises: performing an exclusive or operation on two or more sidelink messages of the group of sidelink messages to generate a subset of sidelink messages of the one or more subsets of sidelink messages, wherein transmitting the one or more network coded combined messages is based at least in part on performing the exclusive or operation.

Aspect 8: The method of any of aspects 1 through 7, further comprising: generating a first matrix including first values, the first values indicating a requested retransmission for one or more sidelink messages of the group of sidelink messages based at least in part on the feedback information, wherein generating the one or more network coded combined messages corresponding to the one or more subsets of sidelink messages is based at least in part on the first matrix.

Aspect 9: The method of aspect 8, wherein each column of the first matrix corresponds to a respective sidelink message of the group of sidelink messages; and each row of the first matrix corresponds to a respective UE of a plurality of UEs associated with the feedback information.

Aspect 10: The method of any of aspects 8 through 9, further comprising: identifying a first set of sidelink messages of the plurality of sidelink messages for which a UE requests retransmission and a second set of sidelink messages of the plurality of sidelink messages for which the UE fails to request retransmission; generating, for the UE, one or more rows in the first matrix, each row of the one or more rows corresponding to a respective sidelink message of the first set of sidelink messages; and identifying, in each row of the first matrix associated with the UE, the second set of sidelink messages using one or more second values.

Aspect 11: The method of any of aspects 8 through 10, further comprising: generating a second matrix based at least in part on determining two or more first values of the first matrix that represent a sidelink message stored at a same storage location.

Aspect 12: The method of aspect 11, further comprising: adjusting a value of one of the two or more first values to reduce a rank associated with the first matrix, wherein generating the second matrix is based at least in part on adjusting the value.

Aspect 13: The method of any of aspects 11 through 12, further comprising: generating a third matrix based at least in part on a row basis of the second matrix, wherein generating the one or more network coded combined messages corresponding to the one or more subsets of sidelink messages of the group of sidelink messages is based at least in part on generating the third matrix.

Aspect 14: The method of aspect 13, wherein the indication of the one or more subsets of sidelink messages comprises one or more rows of the third matrix.

Aspect 15: The method of any of aspects 8 through 14, further comprising: generating a third matrix based at least in part on a row basis of the first matrix, wherein generating the one or more network coded combined messages corresponding to the one or more subsets of sidelink messages of the group of sidelink messages is based at least in part on generating the third matrix.

Aspect 16: The method of aspect 15, wherein the indication of the one or more subsets of sidelink messages comprises one or more rows of the third matrix.

Aspect 17: The method of any of aspects 1 through 16, further comprising: identifying a reliability threshold for one or more sidelink messages of the plurality of sidelink messages, wherein transmitting the one or more network coded combined messages is based at least in part on the reliability threshold.

Aspect 18: The method of any of aspects 1 through 17, wherein the one or more network coded combined messages are associated with an internet protocol layer, a packet data convergence protocol layer, a radio link control layer, a medium access control layer, or any combination thereof.

Aspect 19: The method of any of aspects 1 through 18, wherein the relay node comprises a sidelink UE.

Aspect 20: The method of any of aspects 1 through 19, further comprising: transmitting SCI indicating whether one or more sidelink messages scheduled by the SCI are network coded combined messages.

Aspect 21: A method for wireless communication at a UE, comprising: transmitting a sidelink message to one or more UEs of a plurality of UEs; receiving a set of sidelink messages from the plurality of UEs via one or more sidelink channels; transmitting feedback information associated with the set of sidelink messages, the feedback information requesting retransmission for at least one sidelink message of the set of sidelink messages; and receiving one or more network coded combined messages corresponding to one or more subsets of sidelink messages of the set of sidelink messages including the at least one sidelink message based at least in part on the feedback information, the one or more network coded combined messages including an indication of the one or more subsets of sidelink messages.

Aspect 22: The method of aspect 21, wherein the feedback information indicates a negative acknowledgement, a positive acknowledgement, or a combination thereof, for each sidelink message of the set of sidelink messages.

Aspect 23: The method of any of aspects 21 through 22, wherein the feedback information indicates a storage capability of the UE for storing a set of decoded sidelink messages.

Aspect 24: The method of aspect 23, wherein the storage capability indicates a capability of the UE to store a quantity of decoded sidelink messages, a quantity of network coded sidelink messages, or any combination thereof, for the set of sidelink messages.

Aspect 25: The method of any of aspects 21 through 24, wherein the storage capability indicates one or more decoded sidelink messages stored at the UE, one or more network coded sidelink messages stored at the UE, or a combination thereof.

Aspect 26: The method of any of aspects 21 through 25, further comprising: storing, at the UE, one or more decoded sidelink messages of the set of sidelink messages; and performing an exclusive or operation on the one or more decoded sidelink messages, the sidelink message, and the one or more network coded combined messages to obtain the at least one sidelink message.

Aspect 27: The method of aspect 26, wherein the feedback information indicates a storage capability of the UE for storing the one or more decoded sidelink messages.

Aspect 28: The method of any of aspects 26 through 27, wherein the feedback information indicates the one or more decoded sidelink messages stored at the UE.

Aspect 29: The method of any of aspects 21 through 28, further comprising: performing an exclusive or operation on the sidelink message and one or more decoded sidelink messages of the set of sidelink messages to obtain a network coded sidelink message; storing, at the UE, the network coded sidelink message; and performing an exclusive or operation on the network coded sidelink message and the one or more network coded combined messages to obtain the at least one sidelink message.

Aspect 30: The method of aspect 29, wherein the feedback information indicates a storage capability of the UE for storing the network coded sidelink message.

Aspect 31: The method of any of aspects 29 through 30, wherein the feedback information indicates the one or more decoded sidelink messages associated with the network coded sidelink message stored at the UE.

Aspect 32: The method of any of aspects 21 through 31, wherein the one or more network coded combined messages are associated with an internet protocol layer, a packet data convergence protocol layer, a radio link control layer, a medium access control layer, or any combination thereof.

Aspect 33: The method of any of aspects 21 through 32, wherein the one or more network coded combined messages are received from a relay node.

Aspect 34: The method of any of aspects 21 through 33, further comprising: receiving SCI indicating whether one or more sidelink messages scheduled by the SCI are network coded combined messages.

Aspect 35: An apparatus for wireless communication at a relay node, comprising a processor; memory coupled with the processor; and instructions stored in the memory and executable by the processor to cause the apparatus to perform a method of any of aspects 1 through 20.

Aspect 36: An apparatus for wireless communication at a relay node, comprising at least one means for performing a method of any of aspects 1 through 20.

Aspect 37: A non-transitory computer-readable medium storing code for wireless communication at a relay node, the code comprising instructions executable by a processor to perform a method of any of aspects 1 through 20.

Aspect 38: An apparatus for wireless communication at a UE, comprising a processor; memory coupled with the processor; and instructions stored in the memory and executable by the processor to cause the apparatus to perform a method of any of aspects 21 through 34.

Aspect 39: An apparatus for wireless communication at a UE, comprising at least one means for performing a method of any of aspects 21 through 34.

Aspect 40: A non-transitory computer-readable medium storing code for wireless communication at a UE, the code comprising instructions executable by a processor to perform a method of any of aspects 21 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a relay node, comprising:
receiving a plurality of sidelink messages via one or more sidelink channels, the plurality of sidelink messages including a group of sidelink messages associated with feedback information requesting retransmission for each sidelink message of the group of sidelink messages;
generating one or more network coded combined messages corresponding to one or more subsets of sidelink messages of the group of sidelink messages based at least in part on the feedback information; and
transmitting, via the one or more sidelink channels, the one or more network coded combined messages and an indication of the one or more subsets of sidelink messages of the group of sidelink messages.

2. The method of claim 1, further comprising:
receiving the feedback information from a plurality of user equipments (UEs) based at least in part on receiving the plurality of sidelink messages, wherein generating the one or more network coded combined messages is based at least in part on receiving the feedback information.

3. The method of claim 2, wherein the feedback information indicates a negative acknowledgement, a positive acknowledgement, or a combination thereof, for one or more sidelink messages of the group of sidelink messages.

4. The method of claim 2, wherein the feedback information indicates, for each UE of the plurality of UEs, a storage capability for storing a set of decoded sidelink messages.

5. (canceled)

6. The method of claim 2, wherein the feedback information indicates, for each UE of the plurality of UEs, one or more decoded sidelink messages stored at the UE, one or more network coded sidelink messages stored at the UE, or a combination thereof.

7. The method of claim 1, wherein generating the one or more network coded combined messages further comprises:
performing an exclusive or operation on two or more sidelink messages of the group of sidelink messages to generate a subset of sidelink messages of the one or more subsets of sidelink messages, wherein transmitting the one or more network coded combined messages is based at least in part on performing the exclusive or operation.

8. The method of claim 1, further comprising:
generating a first matrix including first values, the first values indicating a requested retransmission for one or more sidelink messages of the group of sidelink messages based at least in part on the feedback information, wherein generating the one or more network coded combined messages corresponding to the one or more subsets of sidelink messages is based at least in part on the first matrix.

9. The method of claim 8, wherein:
each column of the first matrix corresponds to a respective sidelink message of the group of sidelink messages; and
each row of the first matrix corresponds to a respective user equipment (UE) of a plurality of UEs associated with the feedback information.

10. The method of claim 8, further comprising:
identifying a first set of sidelink messages of the plurality of sidelink messages for which a user equipment (UE) requests retransmission and a second set of sidelink messages of the plurality of sidelink messages for which the UE fails to request retransmission;
generating, for the UE, one or more rows in the first matrix, each row of the one or more rows corresponding to a respective sidelink message of the first set of sidelink messages; and
identifying, in each row of the first matrix associated with the UE, the second set of sidelink messages using one or more second values.

11. The method of claim 8, further comprising:
generating a second matrix based at least in part on determining two or more first values of the first matrix that represent a sidelink message stored at a same storage location.

12-16. (canceled)

17. The method of claim 1, further comprising:
identifying a reliability threshold for one or more sidelink messages of the plurality of sidelink messages, wherein transmitting the one or more network coded combined messages is based at least in part on the reliability threshold.

18-19. (canceled)

20. The method of claim 1, further comprising:
transmitting sidelink control information indicating whether one or more sidelink messages scheduled by the sidelink control information are network coded combined messages.

21. A method for wireless communication at a user equipment (UE), comprising:
transmitting a sidelink message to one or more UEs of a plurality of UEs;
receiving a set of sidelink messages from the plurality of UEs via one or more sidelink channels;
transmitting feedback information associated with the set of sidelink messages, the feedback information requesting retransmission for at least one sidelink message of the set of sidelink messages; and
receiving one or more network coded combined messages corresponding to one or more subsets of sidelink messages of the set of sidelink messages including the at least one sidelink message based at least in part on the feedback information, the one or more network coded combined messages including an indication of the one or more subsets of sidelink messages.

22. The method of claim 21, wherein the feedback information indicates a negative acknowledgement, a positive acknowledgement, or a combination thereof, for each sidelink message of the set of sidelink messages.

23. The method of claim 21, wherein the feedback information indicates a storage capability of the UE for storing a set of decoded sidelink messages.

24-25. (canceled)

26. The method of claim 21, further comprising:
storing, at the UE, one or more decoded sidelink messages of the set of sidelink messages; and
performing an exclusive or operation on the one or more decoded sidelink messages, the sidelink message, and the one or more network coded combined messages to obtain the at least one sidelink message.

27-28. (canceled)

29. The method of claim 21, further comprising:
performing an exclusive or operation on the sidelink message and one or more decoded sidelink messages of the set of sidelink messages to obtain a network coded sidelink message;
storing, at the UE, the network coded sidelink message; and
performing an exclusive or operation on the network coded sidelink message and the one or more network coded combined messages to obtain the at least one sidelink message.

30-32. (canceled)

33. The method of claim 21, wherein the one or more network coded combined messages are received from a relay node.

34. (canceled)

35. An apparatus for wireless communication at a relay node, comprising:
a processor;
memory coupled with the processor; and
instructions stored in the memory and executable by the processor to cause the apparatus to:
receive a plurality of sidelink messages via one or more sidelink channels, the plurality of sidelink messages including a group of sidelink messages associated with feedback information requesting retransmission for each sidelink message of the group of sidelink messages;
generate one or more network coded combined messages corresponding to one or more subsets of sidelink messages of the group of sidelink messages based at least in part on the feedback information; and
transmit, via the one or more sidelink channels, the one or more network coded combined messages and an indication of the one or more subsets of sidelink messages of the group of sidelink messages.

36. The apparatus of claim 35, wherein the instructions are further executable by the processor to cause the apparatus to:
receive the feedback information from a plurality of user equipments (UEs) based at least in part on receiving the plurality of sidelink messages, wherein generating the one or more network coded combined messages is based at least in part on receiving the feedback information.

37-40. (canceled)

41. The apparatus of claim 35, wherein the instructions to generate the one or more network coded combined messages are further executable by the processor to cause the apparatus to:
perform an exclusive or operation on two or more sidelink messages of the group of sidelink messages to generate a subset of sidelink messages of the one or more subsets of sidelink messages, wherein transmitting the one or more network coded combined messages is based at least in part on performing the exclusive or operation.

42. The apparatus of claim 35, wherein the instructions are further executable by the processor to cause the apparatus to:
generate a first matrix including first values, the first values indicating a requested retransmission for one or more sidelink messages of the group pf sidelink messages based at least in part on the feedback information, wherein generating the one or more network coded combined messages corresponding to the one or more subsets of sidelink messages is based at least in part on the first matrix.

43-50. (canceled)

51. The apparatus of claim 35, wherein the instructions are further executable by the processor to cause the apparatus to:
identify a reliability threshold for one or more sidelink messages of the plurality of sidelink messages, wherein transmitting the one or more network coded combined messages is based at least in part on the reliability threshold.

52. (canceled)

53. The apparatus of claim 35, wherein the relay node comprises a sidelink user equipment (UE).

54. The apparatus of claim 35, wherein the instructions are further executable by the processor to cause the apparatus to:
transmit sidelink control information indicating whether one or more sidelink messages scheduled by the sidelink control information are network coded combined messages.

55. An apparatus for wireless communication at a user equipment (UE), comprising:
a processor;
memory coupled with the processor; and
instructions stored in the memory and executable by the processor to cause the apparatus to:
transmit a sidelink message to one or more UEs of a plurality of UEs;
receive a set of sidelink messages from the plurality of UEs via one or more sidelink channels;
transmit feedback information associated with the set of sidelink messages, the feedback information requesting retransmission for at least one sidelink message of the set of sidelink messages; and
receive one or more network coded combined messages corresponding to one or more subsets of sidelink messages of the set of sidelink messages including the at least one sidelink message based at least in part on the feedback information, the one or more network coded combined messages including an indication of the one or more subsets of sidelink messages.

56. The apparatus of claim 55, wherein the feedback information indicates a negative acknowledgement, a positive acknowledgement, or a combination thereof, for each sidelink message of the set of sidelink messages.

57. The apparatus of claim 55, wherein the feedback information indicates a storage capability of the UE for storing a set of decoded sidelink messages.

58-59. (canceled)

60. The apparatus of claim 55, wherein the instructions are further executable by the processor to cause the apparatus to:
store, at the UE, one or more decoded sidelink messages of the set of sidelink messages; and
perform an exclusive or operation on the one or more decoded sidelink messages, the sidelink message, and the one or more network coded combined messages to obtain the at least one sidelink message.

61-62. (canceled)

63. The apparatus of claim 55, wherein the instructions are further executable by the processor to cause the apparatus to:
perform an exclusive or operation on the sidelink message and one or more decoded sidelink messages of the set of sidelink messages to obtain a network coded sidelink message;
store, at the UE, the network coded sidelink message; and
perform an exclusive or operation on the network coded sidelink message and the one or more network coded combined messages to obtain the at least one sidelink message.

64-68. (canceled)
